(19) United States
(12) Patent Application Publication
(10) Pub. No.: US 2004/0139141 A1
(43) Pub. Date: Jul. 15, 2004

(54) Integration of virtual data within a host operating environment

(76) Inventor: Michael R. Lessard, Nottingham, NH (US)

Correspondence Address: Brown Raysman Millstein Felder & Steiner LLP, Attorney for Applicants, 900 Third Avenue, New York, NY, 10022, US

(21) Appl. No.: 10/334,819

(22) Filed: Dec. 31, 2002

(51) Int. Cl. G06F 17/00

(52) U.S. Cl. 709/200

(57) ABSTRACT

The present invention provides methods and systems for virtualizing data as virtual native data to a host operating environment, in which at least a portion of the data is from a source that is external to the host operating environment. A set of data is virtualized, including integrating at least a portion of the set of data with at least a portion of an obtained set of virtual data. The integrating can generate a resulting data set, such as a data object. Additional data sets can be virtualized and integrated with generated resulting data sets through recursive iteration.

### CROSS-REFERENCE TO RELATED APPLICATIONS

This application is related to the following U.S. applications: application Ser. No. 09/877,609 filed on Jun. 8, 2001, now pending; application Serial No. 09/877,513, filed on Jun. 8, 2001, now pending; and, application Ser. No. 09/969,956 filed on Oct. 3, 2001, now pending, all of which applications are hereby incorporated herein in their entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

This invention relates in general to networked computer systems, and in particular to methods and systems for allowing use of data within a host operating environment in a networked computer system.

A modern business enterprise typically utilizes a networked computer system, in which users of individual client computers have access through a network to a server computer or server computers which provide the users with an operating environment, or host operating environment, through which the users can utilize one or more applications. The term “host operating environment” is here used broadly to include the computing environment provided by a server computer or server computers to one or more client computers, allowing one or more client computers access to and interface with various software, telecommunications methods, etc. provided by the server computer or server computers. The term “applications” is here used broadly to include various software programs that carry out some useful task, including tools and utilities. Frequently, a wide array of applications may be made available to provide an enterprise wide solution, including database applications, communications packages, graphics applications management tools, security-related applications, word processing applications, spreadsheet applications, intranet and/or Internet applications, various messaging applications, etc. In some instances, the applications may be integrated as part of an integrated application suite.

Data is of course frequently utilized by being accessed and manipulated by client computers through the use of the applications of the host operating environment. Access and manipulation activities include such actions as data searches, interrogation, replication, archiving, presentations, find and replace functions, mathematical operations, etc. Nonvolatile data storage is typically provided such that the data can be accessed and utilized by the applications of the host operating environment, e.g., integrated with the host environment, without the need to use emulator software or other programs, such as linking programs or utilities, to provide a translation or link between the host operating system and the data source. Data accessible by a host operating system in the foregoing way is herein termed “native” to the host operating system.

A problem often arises, however, when it is desired to access data from one or more non-native sources, e.g., external sources, having external data. External data is generally integrated for use in the application or applications that were designed to utilize the data, but not integrated for use in applications other than those applications, e.g., foreign applications. A group of data sources, each of which is not integrated for use in one or more applications for which at least one of the other data sources is integrated for use with, are referred to herein as a heterogeneous group. Frequently, it is desired for a client computer to access and manipulate external data, either separately from or together with native data. For example, a user of a client computer may wish to perform a search of a data set that includes a native data set and an external data set. Furthermore, a user of a client computer may wish to perform a search of a data set that includes data from several of a heterogeneous group of data sources, or to perform a search of a data set that includes native data and data from several of a heterogeneous group of data sources. Since the external data is not integrated for use with the host operating system, a difficulty arises. This difficulty may be exacerbated by the fact that the user of the client computer may be comfortable in, and skilled in using, the host operating environment and applications provided therein, and may be greatly inconvenienced if required to work outside of that environment. In addition, particular applications provided within the host operating environment may provide particular utility that is not available or not easily available outside the host operating environment.

Various approaches have been taken to dealing with this type of problem or similar types of problems as they arise in various different computing contexts. One approach, as described in U.S. Pat. No. 6,078,924, has been to create a single information platform that is intended to allow integration of data from a wide variety of formats. This approach, however, requires, among other things, the use of the described information platform, rather than enabling the use of a particular desired platform.

Various other approaches utilize programs, which may be known as emulator or linking programs, that are intended to provide a link between the host operating environment and an external data source. In providing the link, however, these approaches generally introduce a linking data scheme or system into the host operating environment that is foreign to the external data source and that was foreign to the host operating system prior to the inclusion of the linking program, and through which system external data is typically nonvolatilely stored as native data to the host operating environment, in addition to being stored nonvolatilely in the external data source.

The introduction of a data storage “middleman”, as just described, can cause complications of many sorts. For example, if data that is intended to have a single value and/or identity is nonvolatilely stored in more than one location, and changes to or deletions of the data are made, the possibility arises that the data may be changed in one location without being accordingly changed, or synchronized, in the other location, or without being synchronized sufficiently quickly. This can result in a host of problems, including errors or exceptions in the host operating environment, the need to incorporate cumbersome data checking and exception handling procedures into the host operating environment, loss of data, loss of data integrity, etc. For instance, problems can arise when several client computers attempt to access and manipulate the same data, and the likelihood of such problems tends to become greater as the client actions are closer together in time. To be more specific, one problem that can arise is that changes to data made by a first client computer may not be synchronized before a second client computer accesses what is supposed to be identical data, which can result in errors or loss of data integrity.

In addition to the foregoing problems, many linking programs do not enable external data to be fully utilized and manipulable by applications within the host operating environment to the same extent as data that is native to the host operating environment. The external data thereby does not function as a “first class participant” in the host operating environment. Still further, in this and other ways, linking programs often operate such that, in one way or another, the user is reminded of and often inconvenienced by the operation of the linking program within the host operating environment. In this sense, the operation of linking program is not transparent to a user of the client computer who is accessing and manipulating external data.

There is a need in the art for methods by which client computers working in a host operating environment can access and manipulate data from one or more external data sources, which methods do not require nonvolatile storage of the data as native data to the host operating environment.

### SUMMARY OF THE INVENTION

It is an object of the invention to provide methods for allowing use of external data through a host operating environment as a first class participant in the host operating environment, which methods do not require nonvolatile storage of the external data as native data to the host operating environment.

It is another object of the invention to provide methods for virtualizing external data as virtual native data, the virtual native data being native to a host operating environment, to allow use of external data through the host operating environment.

In one embodiment, the invention provides, in a computer network having a server computer and a client computer connectable through the network to the server computer, in which an operating environment is available to the client computer, a method for integrating a set of data into the operating environment, wherein the set of data is from at least one source that is external to the operating environment. The method includes providing a connection between the network and the at least one source through which the set of data is retrieved through a host operating environment; adapting the set of data for use through the host operating environment; and, the client computer using the adapted data through the host operating environment, wherein the adapting and the using do not require nonvolatile storage of the set of data as native data to the host operating environment.

In another embodiment, the invention provides a method for virtualizing external data as virtual native data, the external data being from a source that is external to a host operating environment, and the virtual native data being native to the host operating environment. The method includes determining an external data set to be virtualized as a plurality of virtual native documents, the plurality of virtual native documents being native to the host operating environment; determining mapping data to associate each of a first set of data groups from the external data set with fields of the plurality of virtual native documents; utilizing the mapping data, determining wrapping data associated with each of a second set of data groups from the external data set, the wrapping data being for specifying characteristics of external data from the external data set as the fields of the plurality of virtual native documents; and, utilizing the wrapping data, allowing use of the external data through the host operating environment.

In another embodiment, the invention provides a method for virtualizing external data as virtual native data, the external data being from a source that is external to a host operating environment, and the virtual native data being native to the host operating environment. The method includes determining an external data table having a plurality of rows to be virtualized as a plurality of virtual native documents, the plurality of virtual native documents being native to the host operating environment; determining mapping data to associate columns from the external data table with fields of the plurality of virtual native documents; utilizing the mapping data, determining wrapping data associated with each of a plurality of rows from the external data table, the wrapping data being for specifying characteristics of each row of external data from the external data table as a virtual native document of the plurality of virtual native documents; and utilizing the wrapping data, allowing use of the external data through the host operating environment.

In another embodiment, the invention provides a method for virtualizing data as virtual native data to a host operating environment. The method includes obtaining a first set of virtual native data, the first set of virtual native data being virtualized as virtual native data to the host operating environment, and at least a portion of the first set of virtual native data including data from a source that is external to the host operating environment. The method further includes virtualizing a second set of data as virtual native data to the host operating environment, at least a portion of the second set of data including data from a source that is external to the host operating environment, including integrating at least a portion of the second set of data with at least a portion of the obtained first set of virtual data.

In another embodiment, the invention provides a system for virtualizing data as virtual native data to a host operating environment. The system includes a client computer through which data can be retrieved through the host operating environment. The system further includes at least one server computer connectable to the client computer and capable of being utilized in making the host operating environment available to the client computer. The at least one server computer is capable of being utilized for obtaining a first set of virtual native data, the first set of virtual native data being virtualized as virtual native data to the host operating environment, and at least a portion of the first set of virtual native data including data from a source that is external to the host operating environment. The at least one server is further capable of being utilized for virtualizing a second set of data as virtual native data to the host operating environment, at least a portion of the second set of data including data from a source that is external to the host operating environment, including integrating at least a portion of the second set of data with at least a portion of the obtained first set of virtual data.

In another embodiment, the invention provides a computer usable medium storing program code which, when executed on a computerized device, causes the computerized device to execute a method for virtualizing data as virtual native data to a host operating environment. The method includes obtaining a first set of virtual native data, the first set of virtual native data being virtualized as virtual native data to the host operating environment, and at least a portion of the first set of virtual native data including data from a source that is external to the host operating environment. The method further includes virtualizing a second set of data as virtual native data to the host operating environment, at least a portion of the second set of data comprising data from a source that is external to the host operating environment, including integrating at least a portion of the second set of data with at least a portion of the obtained first set of virtual data.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 is a block diagram of a distributed computer system incorporating a data virtualization program, according to one embodiment of the invention;

FIG. 2 is a block diagram of one embodiment of a distributed computer system in accordance with the system depicted in FIG. 1;

FIG. 3 is a block diagram showing operation of a data virtualization program, according to one embodiment of the invention;

FIG. 4 is a flow chart showing a method for integrating external data into a host operating environment, according to one embodiment of the invention;

FIG. 5 is a flow chart showing a method of operation of a data virtualization program, according to the method of FIG. 4;

FIG. 6 depicts an external database having a data table, which data table includes wrapping data, according to one embodiment of the invention;

FIG. 7 depicts an external database having a data table without wrapping data and a data table with wrapping data, according to one embodiment of the invention;

FIG. 8 is a flow chart showing a method for virtualizing data, according to one embodiment of the invention;

FIG. 9 is a flow chart showing a method for utilizing wrapping data for data virtualization, according to one embodiment of the invention;

FIG. 10 is a flow diagram depicting one embodiment of a method for virtualization of a data set, including integrating the data set with an obtained virtual native data set;

FIG. 11 is a block diagram depicting one embodiment of a method for virtualization of a data set, including integrating the data set with an obtained virtual native data set;

FIG. 12 is a block diagram depicting one embodiment of a method for virtualization of a data set as depicted in FIG. 11, in which an obtained virtual native data set includes correlating data;

FIG. 13 is a block diagram depicting another embodiment of a method for virtualization of a data set as depicted in FIG. 11, in which the data set to be virtualized includes correlating data;

FIG. 14 is a flow diagram depicting one embodiment of a method including a series of iterations representing recursive iteration of data virtualization, each iteration of data virtualization including integrating a data set with a virtual native data set;

FIG. 15 is a block diagram depicting one embodiment of a method including recursive iteration of data virtualization, each iteration of data virtualization including integrating a data set with a virtual native data set;

FIG. 16 is a flow diagram depicting one embodiment of a method including recursive iteration of data virtualization, each iteration of data virtualization including integrating a data set with a virtual native data set;

FIG. 17 is a block diagram depicting one embodiment of a method including a series of iterations representing recursive iteration of data virtualization, each iteration of data virtualization including integrating a data set with a virtual native data set;

FIG. 18 is a block diagram depicting monitoring of a document, according to one embodiment of the invention;

FIG. 19 is a block diagram depicting a relationship between virtual fields activity and virtual documents activity, according to one embodiment of the invention; and

FIG. 20 is a block diagram depicting a monitored document, according to one embodiment of the invention.

### DETAILED DESCRIPTION OF THE PREFERRED EMBODIMENT

In the following description of the preferred embodiment, reference is made to the accompanying drawings that form a part hereof, and in which is shown by way of illustration a specific embodiment in which the invention may be practiced. It is to be understood that other embodiments may be utilized and structural changes may be made without departing from the scope of the present invention.

In one embodiment, the present invention generally provides methods by which client computers working in a host operating environment can access and manipulate data from one or more external data sources, which methods do not require nonvolatile storage of the data as native data to the host operating environment. In another embodiment, the invention generally provides a method for virtualizing an external data set as a plurality of virtual native documents, and allowing use of external data from the external data set through the host operating environment.

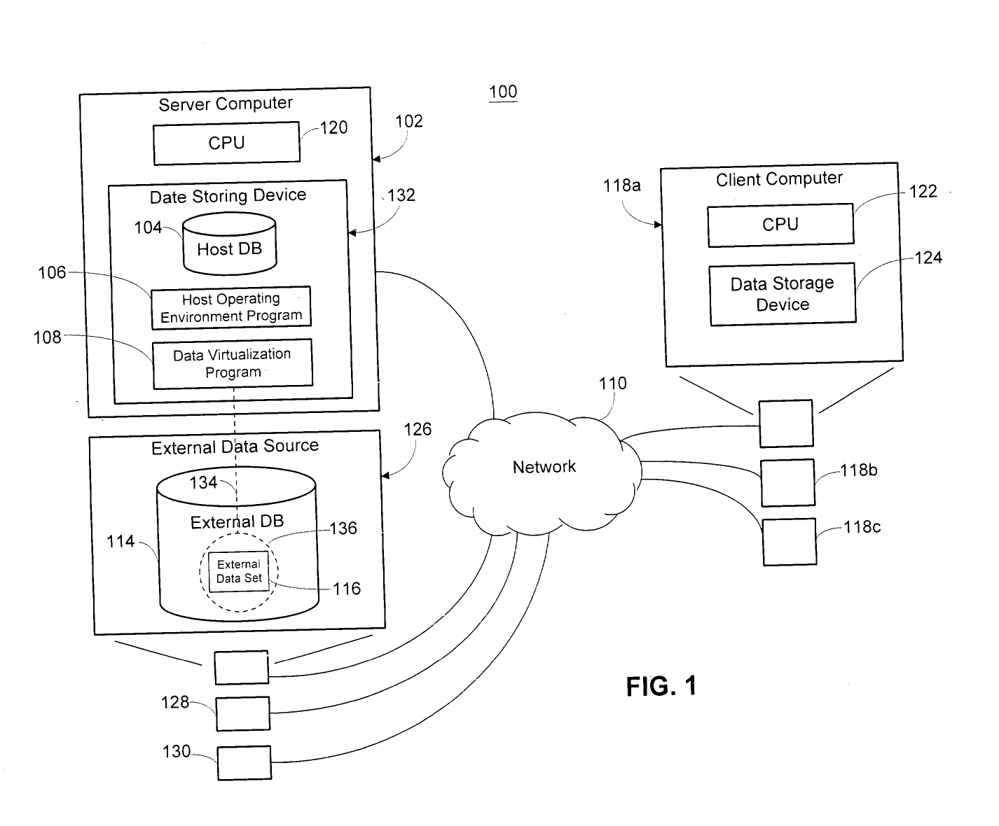

FIG. 1 is a block diagram of a distributed computer system 100 incorporating a data virtualization program 108, according to one embodiment of the invention. In the computer system 100 depicted in FIG. 1, a server computer 102 is connected to one or more external data sources 126, 128, 130 (three are shown), such as heterogeneous external data sources, and one or more client computers 118a-c (three are shown) via a network 110. The external data source 126 can be, for instance, a data store existing within a data storage device within a relational database management system. Although one server computer 102 is shown, the invention also contemplates multiple server computers. The network 110 depicted can broadly include an array of networks, which can include one or more local area networks, one or more wide area networks, and may also include a connection to the Internet, although embodiments of the invention are contemplated in which no connection to the Internet is provided.

Each client computer 118a-c comprises one or more Central Processing Units (CPUs) 122, and one or more data storage devices 124 which may include one or more Internet Browser programs.

The server computer 102 comprises one or more CPUs 120 and one or more data storage devices 132. The data storage device 132 comprises a host operating environment program 106, one or more host databases 104, which is a database that is native to the host operating environment provided by the host operating environment program 106 and contains native data, and a data virtualization program 108. The external data source 126 comprises one or more external databases 114 comprising one or more external data sets 116.

The data storage device 132 of the server computer 102 and the data storage devices of the client computers 118a-c, as well as the external data sources 126, 128, 130, may comprise various amounts of RAM for storing computer programs and other data. In addition, both the server computer 102 and the client computers 118a-c may include other components typically found in computers, including one or more output devices such as monitors, other fixed or removable data storage devices such as hard disks, floppy disk drives and CD-ROM drives, and one or more input devices, such as mouse pointing devices and keyboards.

Generally, both the server computer 102 and the client computers 118a-c operate under and execute computer programs under the control of an operating system, such as Windows, Macintosh, UNIX, etc. In the embodiment shown, the invention is implemented using the data virtualization program 108 executed from the server computer 102, although in alternative embodiments the data virtualization program 108 could be located and executed from one of the client computer 118a-c, or elsewhere. In addition, while in the embodiment shown the host operating environment program 106 is executed from the server computer 102, the invention also contemplates embodiments in which the host operating environment program 106 is located and executed elsewhere. The “host operating environment program” 106 is intended to be broadly interpreted as a composite, and may include and provide numerous applications that are part of a host operating environment extended to the client computers 118a-c.

The data virtualization program 108 is intended to broadly represent programming within or affecting the host operating environment to implement the methods of the invention within the distributed computer system 100 as described herein, and may include manipulation of the host operating environment or applications therein, such as by utilizing application programming interface (API) tools or other tools, as well as programs entirely introduced into the host operating environment. Furthermore, the data virtualization program can include programming for establishing and maintaining connection between a host operating environment and an external data source or sources. In some embodiments of the invention, the data virtualization program 108 includes programming to allow interface with and input from a system administrator or other user or manager of a host operating environment.

Generally, the computer programs of the present invention are tangibly embodied in a computer-readable medium, e.g., one or more data storage devices attached to a computer. Under the control of an operating system, computer programs may be loaded from data storage devices into computer RAM for subsequent execution by the CPU. The computer programs comprise instructions which, when read and executed by the computer, cause the computer to perform the steps necessary to execute elements of the present invention.

The invention contemplates utility at least in situations in which one or more of the client computers 118a-c, connected to the network 110, request or attempt, through the host operating environment of the server computer 102, to utilize a data set 116 from the external data source 126, or several data sets from one or more of the external data sources 126, 128, 130. In such situations, the data virtualization program 108 is utilized to allow integration of external data as first class participant data into the host operating environment for access and manipulation by one or more of the client computers 118a-c through an application or applications provided by the host operating environment program 106. The data virtualization program 108 is capable of allowing integrating of external data so that it can be accessed and manipulated either together or without native data, and transparently to a user of a client computer 118a-c.

The data virtualization program 108 does not require the importation or copying of data from the external data source 126 to be saved nonvolatilely as native data to the host operating environment; rather, the data virtualization program 108 allows access and manipulation of external data within the host operating environment without requiring the external data to exist as nonvolatilely stored native data. External data only exists as native data volitilely, or transiently, in the context of the access and manipulation within the host operating environment. Changes to external data are saved by updating the external data in the external data source 126.

The data virtualization program 108 provides the programming to enable an external data set 116 to be virtualized as native data to the host operating environment for access and manipulation as a first class participant in an application or applications of the host operating environment, causing the external data set 116 to be fully utilizable by the application. Broken line 134 conceptually represents the function of the data virtualization program 108 in virtualizing the external data set 116. Conceptually, the data virtualization program 108 can be viewed as causing wrapping, as represented by broken circle 136, of the external data set 116 with any necessary attributes, associations, or qualities to allow it to be accessed and manipulated from within the host operating environment. By virtualizing the external data set 116, the data virtualization program 108 allows the external data set 116 to become a first class participant in the applications of the host operating environment, without the need for a nonvolatile data storage scheme to act as a link between the host operating environment and the external data source 126, and without the problems and disadvantages caused by such a scheme.

Since the data virtualization program 108 permits the flow of data between the external data sources 126, 128, 130 and the host operating environment (external data being stored only transiently in the host operating environment), data can also be effectively copied, or changed, edited, added to, or subtracted from, and then copied, from one of the external data sources 126, 128, 130 to one or more other of the external data sources 126, 128, 130, without the data virtualization program 108at any point requiring storage of external data nonvolatilely as native data to the host operating environment.

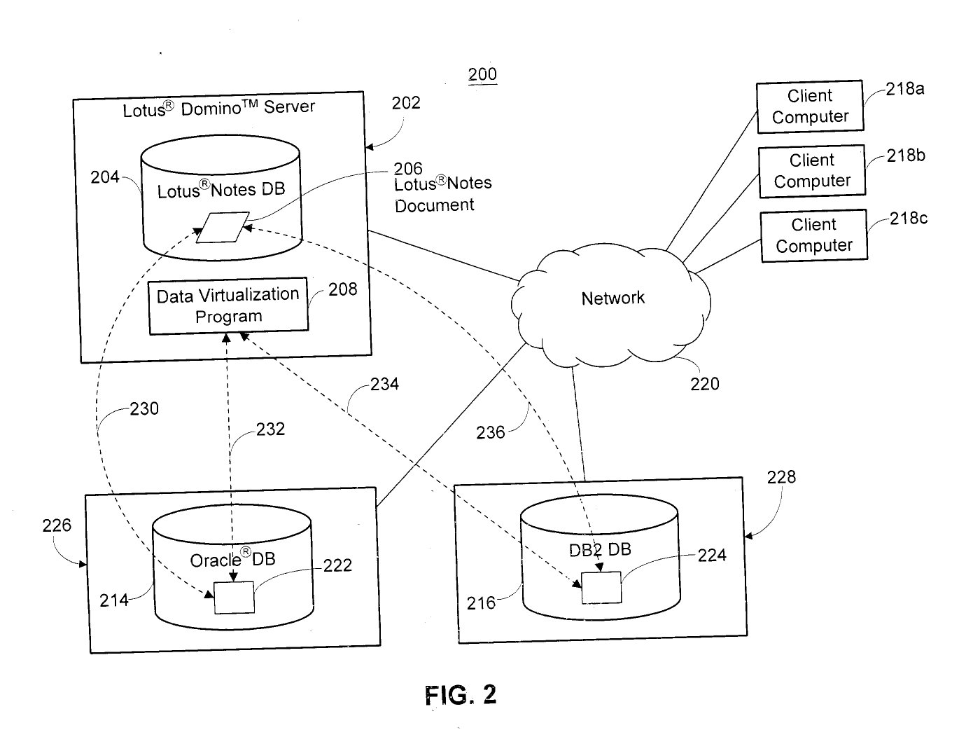

FIG. 2 is a block diagram of one embodiment of a distributed computer system 200 in accordance with the system 100 depicted in FIG. 1. As shown, a Lotus® Domino™ server 202, commercially available from International Business Machines (IBM®) Corporation, is connected via network 220 to an external data source 226 comprising an Oracle® database 214, commercially available from Oracle® Corporation, to an external data source 228 comprising a DB2 database 216, commercially available from IBM® Corporation, and to client computers 218a-c. Other examples of an external data sources that can be used with the present invention include Sybase® databases, available from Sybase® Corporation, Microsoft® Structured Query Language (SQL) servers, and any Open DataBase Compliant (ODBC) data source.

The Lotus® Domino™ server 202 comprises a Lotus® Notes database 204 comprising a Lotus® Notes document 206, and a data virtualization program 208. External databases 226 and 228 comprise external data sets 222 and 224, respectively. The Lotus® Notes document 206 is intended to generically represent any of various forms of data vehicles provided by applications running in the operating environment provided by the Lotus® Domino™ server 202, including various forms, views, and documents, and the term “documents” as used herein is intended to generically represent any of various data vehicles, including, for example, forms, views, and various other document types.

In one embodiment of the invention, a method performed by the system in FIG. 2 begins after one of the client computers 218a-c, via an application provided by the host operating environment, has requested performance of an operation requiring creation of or access to the Lotus® Notes document 206, and the requested operation requires access and manipulation of a data set comprising external data sets 222 and 224 from external data sources 226 and 228, respectively. As conceptually represented by broken arrows 230 and 236, the data virtualization program 208 causes the external data sets 222 and 224 to be associated with all of the attributes of the Lotus® Notes document 206, which may include form information or metadata information, revision history information, document data used by Lotus® Notes or applications running in the host operating environment in identifying the Lotus® Notes document 206, and potentially other information. This, in turn, enables the external data sets 222, 224 to be accessed and manipulated by host operating environment applications as native data. Since the data virtualization program 208 operates to virtualize the external data 222, 224 at the document level, as data associated with or having all the characteristics of a document that is native to the host operating environment, rather than operating at a lower data organizational level, such as the data field level, any linking program data schemes requiring nonvolatile storage of the external data 222, 224 as native data can be avoided while yet enabling first class participation of the external data 222, 224 in the applications of the host operating environment.

Since the external data 222, 224 becomes conceptually wrapped with all of the attributes of native data, such as data contained within a native document, the applications of the host operating environment can operate on the external data 222, 224 just as native data that is stored nonvolatilely can be utilized. Conceptually, the host operating environment sees the external data 222, 224 as native data for purposes of the access and manipulation operation, and the host operating environment and applications provided thereby can operate on the virtualized native data identically to native data. Additionally, the fact that the external data 222, 224 is external data can be transparent to a user of the one of the client computers 218a-c initiating the request communicated to the Lotus® Domino™ server 202 and causing the data access and manipulation. Furthermore, the external data 222, 228, being manipulable through the host operating environment, can be copied or replicated from one of the external sources 226, 228 to the other of the external sources 226, 228, or to one or more other external sources entirely, utilizing the applications of the host operating environment.

In the embodiment depicted in FIG. 2, programming accomplished via the Lotus® Domino™/Notes API and the Lotus®0 Connector API are utilized in establishing the programming framework for connection between the host operating environment and the client computers 218a-c.

The present invention provides many advantages by operating at the document level and yet not requiring nonvolatile storage of external data as native data to a host operating environment. Documents can be conceptually thought of as containers for data, with sets of data assigned to fields of the document. Documents may specify fields within the document, the layout of those fields, and various other attributes of the document itself. Documents are thus a hierarchically higher organizational level of data storage than fields. Since a host operating environment recognizes native documents, data associated with a native document and with a field of the native document has characteristics or attributes within the host operating environment as a result of those associations, and in this sense the data can be thought of as being wrapped with information relating to the associations.

For instance, one kind of document is a form. A simple form could specify the fields that it contains as well as the layout of the fields in the form. Thus, the layout of the fields in the form is an attribute of the form, which may enable it, and the data it contains in its fields, to be used through the host operating environment. Of course, in complex databases and database systems, such as the Lotus® Notes database and others, documents can be much more sophisticated than the simple form just described, and can include hundreds of attributes, which attributes are recognized by the host operating environment to which the document is native. Other attributes of documents can relate, as one of many examples, to security features restricting access to the data contained within the document. The attributes of a document enable the document, and the data contained therein, to be utilized and manipulated in various ways in the host operating environment. Furthermore, as mentioned above complex database systems can include a variety of types of documents, the type of document being characterized by the attributes associated with the document. By virtualizing external data at the document level, the present invention allows a full range of manipulation of the external data, as if the external data were stored nonvolatilely as a document in the host operating environment. In certain embodiments of the invention, external data can be virtualized as a particular type of virtual native document. In different embodiments, the type of document to serve as a virtual native document may be selected by the data virtualization program 208, by a system administrator or other user of one or more of the external data sources 226, 228, or in other ways.

Some systems for allowing use of external data operate at the field level by causing external data to be copied into fields of native documents, sometimes called stub documents, which nonvolatilely stored native documents serve as a vehicle of the host operating environment for allowing use of the data within the host operating environment. Since the external data is copied or imported from the external data source and stored nonvolatilely for use in the host operating environment, changes to the copied external data through the host operating environment must be synchronized with the external data in the external database, to cause the external data stored in the external database to be updating accordingly. The present invention, by contrast, allows use of external data without requiring copying of the data into the host operating environment, so that synchronization is unnecessary. The present invention allows external data to be virtualized at the document level of organization rather than, for example, causing the external data to be copied to and nonvolatilely stored in a host operating environment document.

While the methods of the present invention do not themselves require nonvolatile storage of external data as native data, it should be kept in mind that some host operating environments operate such that external data utilized within the host operating environment is stored nonvolatilely within the host operating system, sometimes for very short periods of time, such as, for example, through file swapping operations. The present invention can be utilized in and maintains its advantages in such host operating environments, and any nonvolatile storage of external data as native data is an incidental to the host operating environment operation and not necessitated by the methods of the invention themselves.

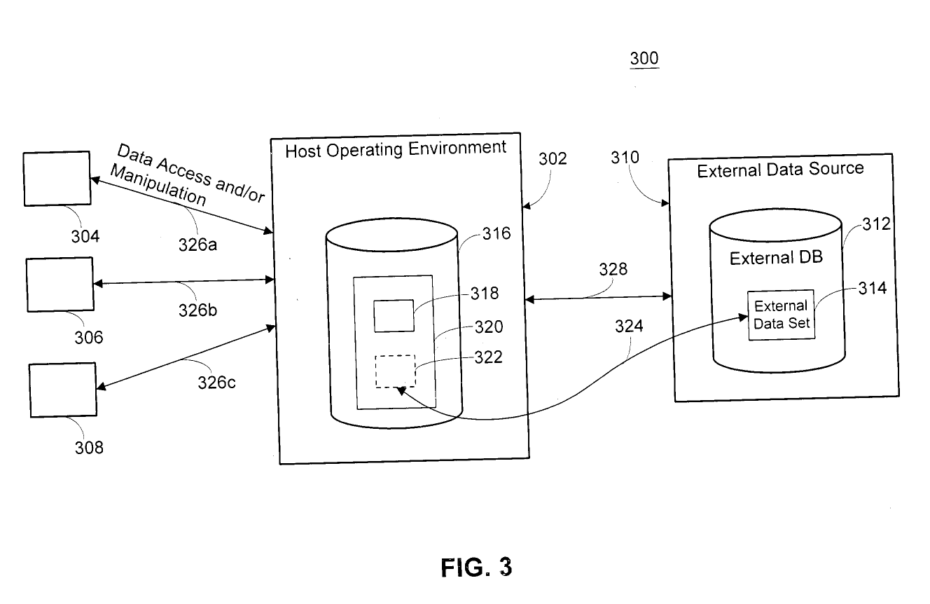

FIG. 3 is a block diagram showing operation of a data virtualization program according to one embodiment of the invention. As shown in FIG. 3, within a conceptually represented host operating environment 302, a native database 316 is shown. The host operating environment 302 is usable by client computers 304, 306, 308 and allows communication with the external data source 310. Native database 316 comprises native data set 320, which can be a native document, form, view or other native data-containing vehicle. External data source 310 comprises external database 312, which comprises external data set 314.

As represented by arrows 326a-c, the client computers 304, 306, 308 can access and manipulate data utilizing the host operating environment 302, and, as represented by arrow 328, two-way communication between the external data source 310 and the host operating environment 302 is provided. As shown, the data set 320 comprises native data set 318, which may be nonvolatilely and/or volatilely stored as native data within the host operating environment 302, and virtualized external data set 322, the virtualized external data set 322 being transiently stored in the host operating environment 302 and being the result of virtualization of external data set 314 by a data virtualization program (not shown). In some embodiments of the invention, data set 320, comprising a combination of the native data 318 and the virtualized external native data set 322, exists during performance of a data access and manipulation action requested by one of the client computers 304, 306, 308 through the host operating environment 302. Although the native data set 318 and the virtualized external data set 322 are represented separately, they may intermingle and be used in an integrated fashion as the data set 320 by applications within the host operating environment 302.

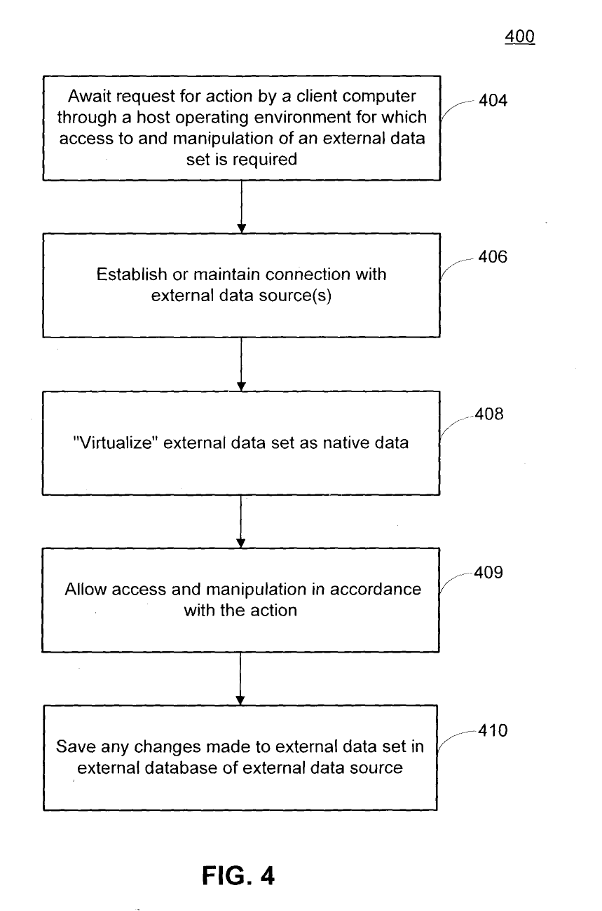

FIG. 4 is a flow chart showing the method 400 of operation of one embodiment of the invention, implemented through the use of a data virtualization program operating within a computer system. The method depicted in FIG. 4 allows access and manipulation through a host operating environment of external data that has been virtualized as native data, referred to as virtualized external data. First, at step 404, the method awaits a request for action by a client computer through a host operating environment, for which access to and manipulation of an external data set is appropriate or required. Step 404 could be, for example, the result of a data search requested by a user of a client computer and communicated to a server computer providing the host operating environment. At step 406, the method 400 establishes a communicative connection with the external data source containing the external data to be accessed and manipulated, or, if a connection exists already, maintains the existing connection. At step 408, the method 400, via operation of the data virtualization program, virtualizes the external data set needed for the requested action. At step 409, the method 400 allows access and manipulation of the virtualized external data set accordingly, via the host operating environment. Note that the action may simultaneously and seamlessly utilize native data as well as the external data that has been virtualized. At step 410, any changes, including edits, additions, and/or deletions, made to the virtualized external data, via the action taken utilizing the operating environment, are saved in an external database of an external data source from which the external data set came. The method 400 represents use of a data virtualization program of one embodiment of the invention to allow access and manipulation of external data through a host operating environment.

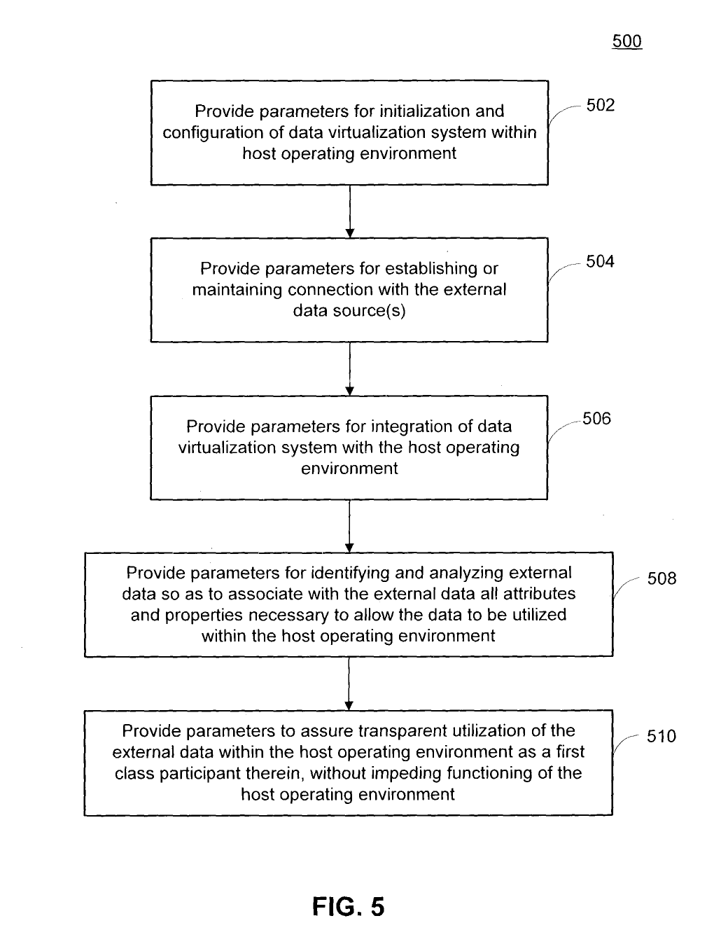

FIG. 5 is a flow chart showing one embodiment of a method 500 of operation of virtualization of data as host data for access and manipulation through a host operating environment. In various embodiments of the invention, various activities included in the steps of method 500 may be performed automatically by the data virtualization program or by a system administrator, network manager or other user of a host operating environment utilizing, for example, applications provided by the data virtualization program and running in the host operating environment.

At step 502, a data virtualization program according to one embodiment of the invention provides parameters for initialization and configuration of a data virtualization system according to one embodiment of the invention within a host operating environment, effectuated by a data virtualization program. In one embodiment of the invention, this includes providing an application enabling a system administrator, network manager, or other user, through an interface provided by the application, to specify the parameters and to specify settings relating to scheduling of data virtualization activity, such as whether such activity should occur on an automatically scheduled basis or a manually selected basis. In one embodiment of the invention, the application is a native application, likely familiar to the user, that provides one or more easy to use point and click forms for selecting configuration option settings. Other aspects of initialization and configuration may be accomplished via an initialization file and a native API.

At step 504, the method 500 provides parameters for establishing or, if already established, maintaining connection with the one or more data sources, which can be at least partially accomplished by programming through the use of APIs. Step 504 can include identifying the type and location of an external data source (e.g., an Oracle® Version 8 database and a machine name or network address), and external data table name or owner information. Additionally, step 504 may include providing security related information, such as user name and password information. Additional security related information can include selecting whether security should be enforced by the host operating environment or by a system associated with the external data source, or both: For example, the user may select whether security should be enforced only by the host operating environment, or whether additional credentials beyond what is needed to use the host operating environment must be provided in order to access an external data source.

At step 506, the method 500 provides parameters for integration of a data virtualization system of the invention with the host operating environment. Typically, step 506 is accomplished through the use of host operating environment APIs. In some embodiments, this involves determining parameters for utilizing event handlers to intercept information relating to certain host operating environment operations being carried out, which operations may, for example, indicate a request by a client computer for an action which requires use of external data. The event handlers may then initiate appropriate data virtualization activity.

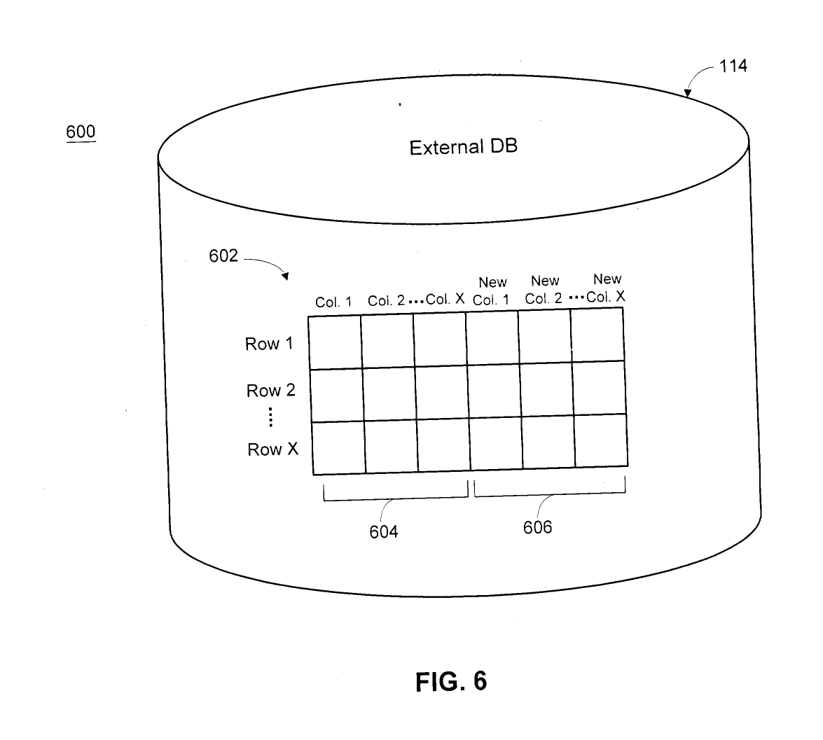

In some embodiments of the invention, steps 508 and 510 of the method 500 are accomplished in part through data mapping activity and storage of nonvolatile storage of wrapping data, as described with reference to FIGS. 6-9.

At step 508, the method 500 provides parameters for identifying and analyzing external data so as to associate with the external data all attributes and properties necessary to allow the data to be utilized within the host operating environment. Step 510 can include data mapping activity, as described with reference to FIGS. 6-9, and specification of how to resolve possible resulting data integrity or data precision issues.

At step 510, the method 500 provides parameters to assure transparent utilization of the external data within the host operating environment as a first class participant therein, without impeding functioning of the host operating environment. In some embodiments, step 510 includes determining and specifying characteristics or attributes that need to be associated with external data so that the data can be used in the host operating environment.

The details of the implementation of the method 500 depicted in FIG. 5, and in fact of many implementations of a data virtualization program or data virtualization system are highly dependent on the particular host operating environment and the particular external data source or sources. However, utilizing the teachings of the invention, one skilled in the art can implement the invention in a variety of settings utilizing common programming skills and procedures.

FIG. 6 depicts an external data source 600 including one embodiment of the external database 114 having an external data table 602 containing external data 604 as well as wrapping; data 606. The external data table 602 comprises a plurality of rows 1-X, the rows 1-X being groups of associated data, and a plurality of columns, including columns 1-X of external data 604 and new columns 1-X of wrapping data 606, each column specifying metadata or data type information associated with data in the column. In the embodiment shown in FIG. 6, the external data set is the external data table 602, and comprises rows and columns; however, the invention also contemplates other types of external data sets and the use of data groups other than rows and columns.

New columns 1-X of wrapping data 606 are added to external data table 602, causing wrapping data to be appended to each row 1-X of external data. In the embodiment shown, the wrapping data 606 is stored nonvolatilely in the external data source 600 in order to specify or identify characteristics or attributes of the external data 604 so as to enable virtualization of the external data 604. One or more particular columns of wrapping data, such as new column 1, may be utilized to provide a unique identifier in the host operating environment for rows of external data.

In one embodiment of the invention, prior to the addition of the wrapping data 606, a system administrator, network manager or other user of the host operating environment specifies or maps columns 1-X of the external data table 602 with associated fields of a native document, so that the appropriate wrapping data 606 can be determined and stored as new columns 1-X by being appended to the rows 1-X of the external data table 602, providing the necessary information for the data virtualization program to allow the external data 604 to be virtualized and used as a first class participant through the host operating environment. In other embodiments of the invention, the mapping function may be performed automatically by a data virtualization program. Mapping results in the determination of mapping data, which can be stored as native data in the host operating environment or in other ways, and which mapping data is utilized by the data virtualization program to virtualize the external data table 602 as a plurality of virtual native documents.

For example, in the embodiment depicted in FIG. 6, each row 1-X of data is associated with a virtual document, specifically, a virtual form. As mentioned above, one of the new columns 1-X of wrapping data 606 can be used to provide a unique identifier record for identifying each particular row, and for identifying the virtual form associated with that row. The fields of each virtual form are populated with data from the associated row. The new columns 1-X supply the wrapping data 606. Various columns of wrapping data for each row can be used by the host operating environment to determine various attributes of the virtual form associated with each row. As just one example, one of the new columns 1-X can specify a security or restricted access characteristic associated with the virtual form associated with that row.

In one embodiment of the invention, the data virtualization program is used to provide wrapping data for a plurality of data tables, such as data table 602, within an external data source, such as the external data source 600, so that all of the external data from the plurality of data tables can be virtualized as a plurality of virtual documents and used through a host operating environment. If virtualized external data, such as the external data 606, is changed, added to, or deleted from through the host operating environment, appropriate updates, additions, or deletions of external data are performed to the external data 606. In addition, wrapping data, such as the wrapping data 606, is updated, added, or deleted, as appropriate.

In addition to initially providing wrapping data 606, a data virtualization program Can be configured to periodically monitor the external data table 602, to provide any necessary updates or additions to the wrapping data 606. For instance, if external data is added to the external data table 6023 through a system external to the host operating environment, such as through a system associated with the external data source 600, a data virtualization program can detect the addition and determine and store wrapping data as appropriate.

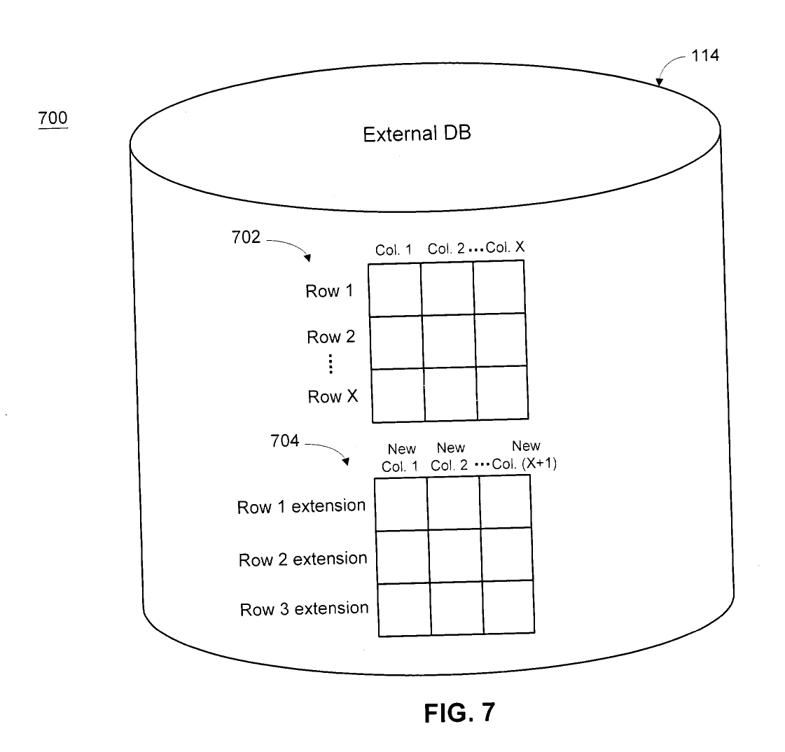

FIG. 7 depicts an alternative embodiment of the external database 114 to the embodiment depicted in FIG. 6. As depicted in FIG. 7, an external data source 700 includes external database 114, which comprises external data table 702, comprising rows 1-X and columns 1-X, and wrapping data table 704, comprising row extensions 1-X and new columns 1-(X+1). In the embodiment depicted in FIG. 7, wrapping data is provided in a separate table 704 from the external data table 702. Wrapping data table 704 requires an additional column of wrapping data as compared with an embodiment in which wrapping data is appended to an external data table, because one column of wrapping data in the wrapping data table must be used to associate the each of the row extensions 1-X of the wrapping data table 702 with each of the rows 1-X of the external data table 704, so that the row extensions 1-X can be used as if they were appended to the rows 1-X. In some situations, the embodiment depicted in FIG. 7 is preferable to the embodiment depicted in FIG. 6 because the embodiment depicted in FIG. 7 does not require any alteration of the external data table 702.

In the embodiments depicted in FIGS. 6 and 7, wrapping data is stored in an external database containing external data that may be virtualized, but in alternative embodiments, the wrapping data can be stored elsewhere and associated with groups of the external data by, for example, a data key.

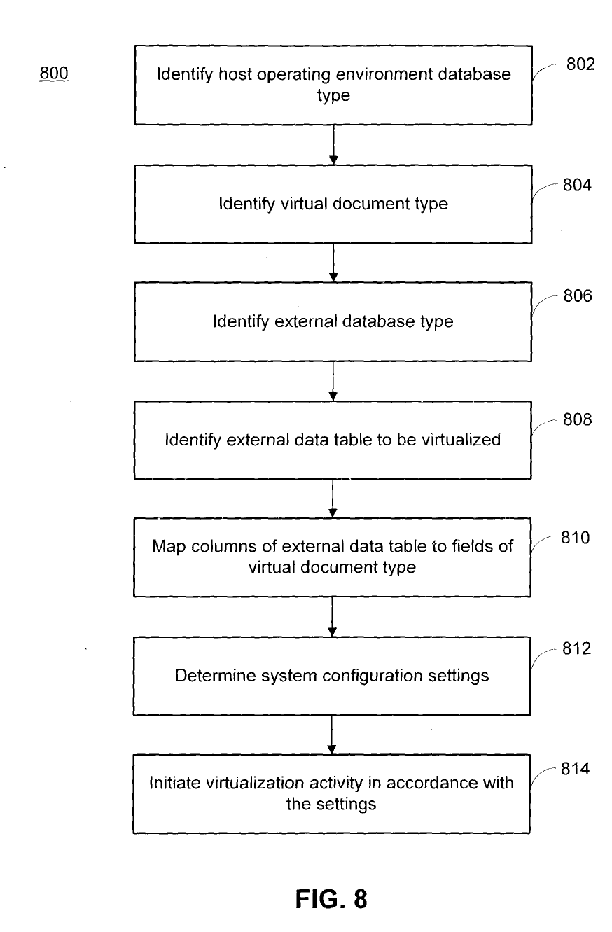

FIG. 8 is a flow chart showing a method 800 for virtualizing data, according to one embodiment of the invention. In various embodiments of the invention, steps of method 800 can be performed automatically by a data virtualization program, or with input from a host operating environment user such as a host operating environment system administrator utilizing a native application provided as part of a data virtualization program.

At step 802, the data virtualization program identifies the host operating environment database type. At step 804, the type of native document to be utilized as a data virtualization document is identified. At step 806, the type of external database is identified. At step 808, the particular type of external data table to be virtualized is identified. At step 810, columns from the external data table are mapped to fields of the type of virtual document as identified at step 804. At step 812, system configurations are determined. At step 814, data virtualization activity is initiated in accordance with the settings. Step 814 could include activating an aspect of the data virtualization program to determine and store wrapping data, monitor the host operating environment to intercept calls that require data virtualization, to monitor an external data tables for changes through an external system and to update wrapping data accordingly. Data virtualization activity also includes utilizing wrapping data to allow use of external data in the host operating environment and updating external data and wrapping data accordingly.

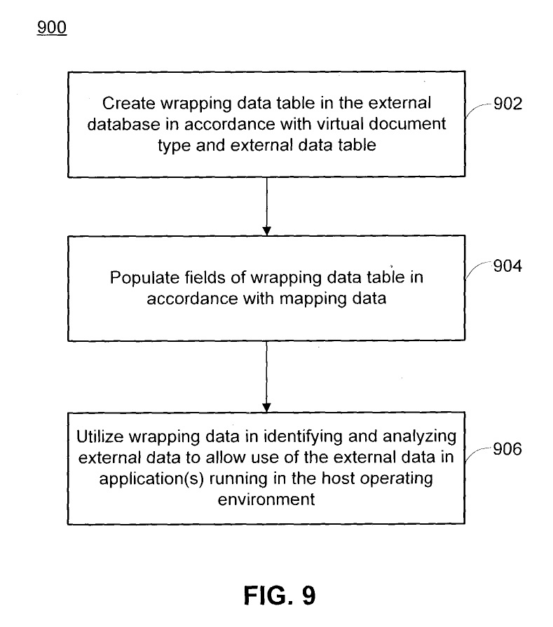

FIG. 9 is a flow chart showing a method 900 for utilizing wrapping data for data virtualization, according to one embodiment of the invention. At step 902, the data virtualization program creates a wrapping data table, such as wrapping data table 704 described with reference to FIG. 7. At step 904, the data virtualization program populates fields of the wrapping data table with wrapping data determined utilizing and in accordance with mapping data.

As described herein and in previously incorporated by reference U.S. application Ser. No. 09/877,513, entitled, “Virtualizing External Data as Native Data,” some embodiments of the invention enable virtualization of data, including external data, as native data to a host operating environment. In some embodiments, this can be accomplished without need for nonvolatile storage of any external data as native data to the host operating environment, so that external data is saved, if at all, only on a transient basis to process data access or manipulation requests. As described in more detail above, by avoiding the need for nonvolatile storage of external data, methods according to some embodiments the invention can thus avoid multiple copies of data leading to synchronization problems or other data integrity problems. Even so, changes to external data that can occur as the result of manipulation of virtual native data can be reflected by appropriately updating external data in the appropriate external data source or sources. Additionally, a user can access and manipulate data objects including data from potentially many disparate sources without even being made aware that the data object contains anything other than native data.

In some embodiments, external data can be utilized as a first class participant in the host operating environment and seamlessly accessed and manipulated along with native data. This can be accomplished transparently to a user, since native and external data can be seamlessly intermingled or otherwise associated, so that the user may not even be aware, or need to be aware, that external data is involved. In some embodiments, not only any user, but also the systems and methods according to the invention, access, treat, operate on, or manipulate, or, conceptually, see, virtual native data identically to non-virtual native data, so that there is no need for either to operate differently whether data is native or virtually native, or, conceptually, to know whether data is native or virtually native.

Since the systems and methods according to some embodiments of the invention conceptually see virtual native data identically to non-virtual native data, the systems and methods can be used not only to combine or otherwise integrate external data with native data, but also, for example, to combine or otherwise integrate virtual native data with other obtained or generated virtual native data. As such, conceptual layering of virtual data can be accomplished, for example, through recursive application of the data virtualization techniques as described herein

A virtual native data set, such as a virtual native data object, virtual native data container, virtual native document, or other virtual native set of associated data, can include virtual native data virtualized from external data, as well as non-virtual native data. In some embodiments of the invention, a virtual native data set, which can include virtual native data virtualized from external data, can be integrated with a generated or otherwise obtained other virtual native data set. This can be conceptually viewed as layering virtual data, the one layer being the generated or otherwise obtained virtual data set, and the other layer being the additional virtualized data. It is to be understood, however, that integration of data sets can include more complex forms of integration than the term “layering” might suggest, including, for example, modifying data from one or several sets based on data from one or several other sets.

Using methods and systems according to the invention, all of the power, utilities, and operations available, for example, through such systems as relational database systems, can be brought to bear on data from potentially many disparate sources. Moreover, such power can include the ability to perform operations in real time involving data from disparate sources which operations themselves build on the results of previous operations. A high degree of data integration or data federation can thereby be achieved, including data from potentially many disparate external enterprises and sources.

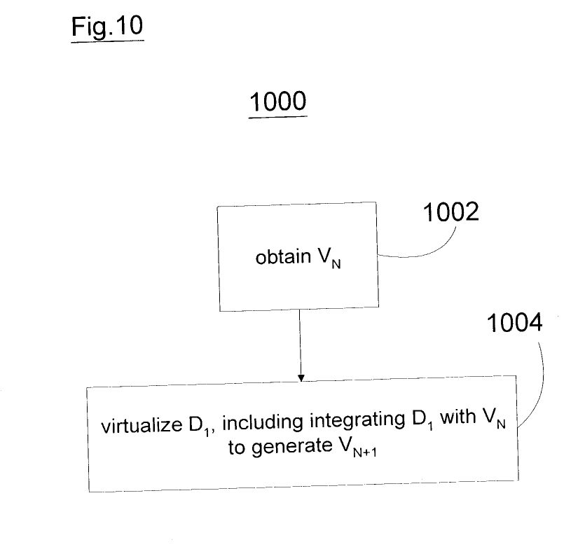

FIG. 10 is a flow diagram depicting one embodiment of a method 1000 for virtualization of a data set, including integrating the data set with an obtained virtual native data set. The method 1000 can be viewed as including layering two sets of virtual native data. At step 1002, a virtual native data set, V_{N}, is obtained, for example, by the data virtualization program 108 as depicted in FIG. 1. It is to be understood that the obtained virtual native data set can be obtained, for example, by having been generated utilizing the data virtualization program 108 as the result of data virtualization, or by having been otherwise obtained by the data virtualization program 108.

At step 1004, the data virtualization program 108 is utilized to virtualize a first data set, D₁, as virtual native data to a host operating environment, such as, for example, the host operating environment 106 as depicted in FIG. 1. It is to be understood that, as described in more detail with reference to FIGS. 1-9 as well as in previously incorporated by reference U.S. application Ser. No. 09/877,513, the first data set, D₁, can include native data as well as virtual native data obtained from external data. In addition, the first data set, D₁, can include data from any number of sources, including multiple, disparate external data sources.

At step 1004, the first data set, D₁, is virtualized, for example, utilizing the data virtualization program 108, including integrating the first data set, D₁, with the obtained virtual native data set, V_{N}, to generate a first resulting virtual native data set, V_{N+1}. It is to be understood that the term “integrate” and forms of the term “integrate,” as used herein, broadly include any form of data manipulation involving data sets of any type, as known in the art. For example, integrating can include any of the following: generating a resulting data set utilizing two or more data sets, associating data sets, combining data sets, relating data sets, joining data sets, augmenting one or more data sets with one or more other data sets, modifying one or more data sets utilizing one or more other data sets, and manipulating one or more data sets utilizing one or more other data sets.

The first resulting virtual native data set, V_{N+1}, while generated utilizing the first data set, D₁ and the obtained virtual native data set, V_{N}, can include data from one, both, or neither of the first data set and the obtained virtual native data set. It is to be understood that, in some embodiments, the first data set, D₁ can include multiple data sets, and the obtained virtual native data set, V_{N}, can also include multiple obtained virtual native data sets.

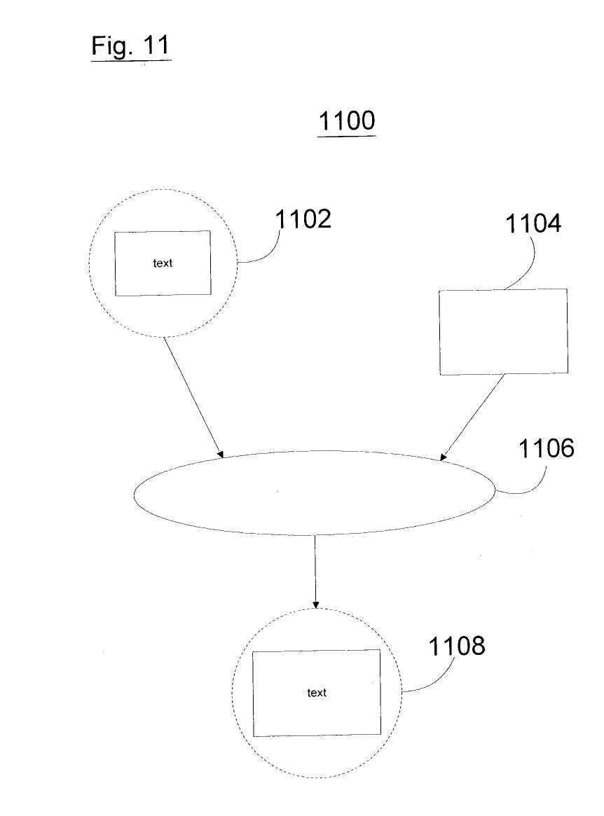

FIG. 11 is a block diagram depicting one embodiment of a method 1100 for virtualization of a data set, including integrating the data set with an obtained virtual native data set. Data set 1104 can include non-virtual as well as virtual data, and can include external as well as native data. Oval 1106 represents virtualization of the data set 1104, including integration of the data set 1104 with obtained virtual native data set 1102, for example, utilizing the data virtualization program 108. As depicted, a resulting virtual native data set 1108 is generated.

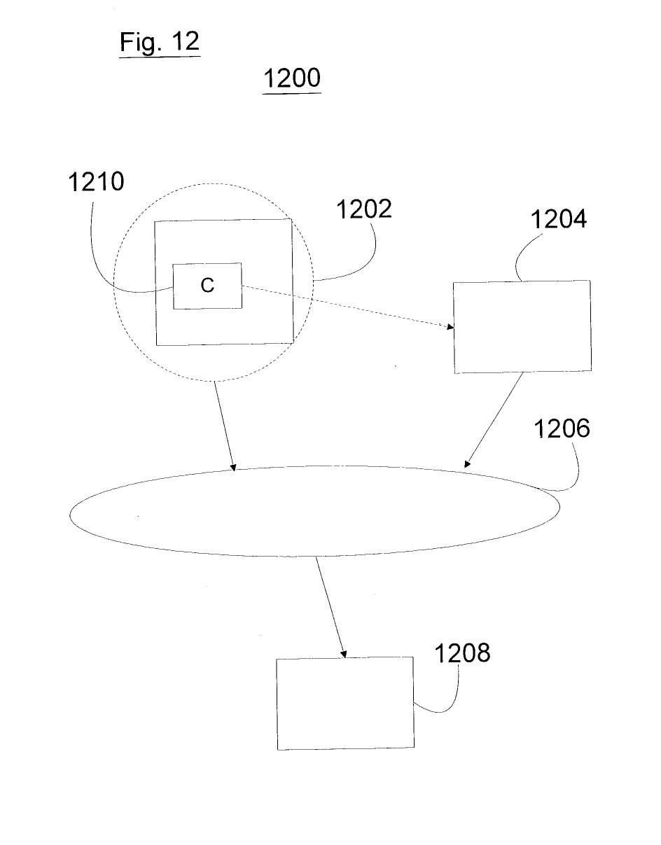

FIG. 12 is a block diagram depicting one embodiment of a method for virtualization of a data set as depicted in FIG. 11, in which an obtained virtual native data set includes correlating data. Oval 1206 represents virtualization of data set 1204, including integration of the data set 1204 with obtained virtual native data set 1202, for example, utilizing the data virtualization program 108. As depicted, a resulting virtual native data set 1208 is generated.

As depicted in FIG. 12, the obtained virtual native data set 1202 includes correlating data 1210. In some embodiments of the invention, as depicted in FIG. 12, correlating data is included as part of an obtained virtual native data set (which obtained virtual native data set can, in some instances, be a resulting virtual native data set, as described above). The correlating data can be used, for example, to specify a location of a data set to be virtualized, including integration with the obtained virtual native data set. As such, the correlating data can provide a key or correlating mechanism, which can be used, for example, by the data virtualization program 108, depicted in FIG. 1, to locate or otherwise access or identify a data set to be virtualized, including integration with the obtained virtual native data set.

In some embodiments, the correlating mechanism can specify information usable, for example, by the data virtualization program 108, in appropriately integrating the data sets. Additionally, in some embodiments, the key or correlating mechanism is itself virtual, generated utilizing the correlating data by or during the virtualization of the data set which contains the correlating data.

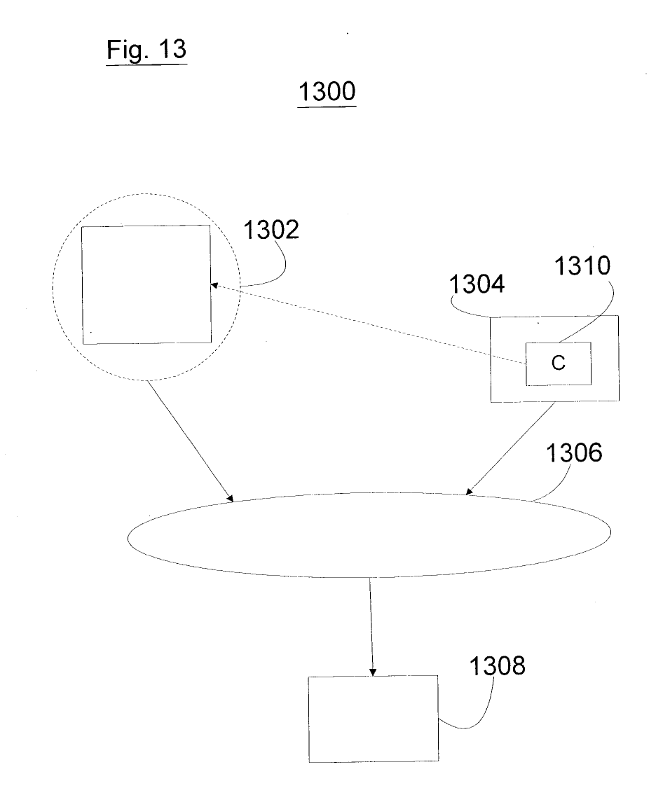

FIG. 13 is a block diagram depicting another embodiment of a method 1300 for virtualization of a data set as depicted in FIG. 11, in which the data set to be virtualized includes correlating data. Oval 1306 represents virtualization of data set 1304, including integration of the data set 1304 with obtained virtual native data set 1302, for example, utilizing the data virtualization program 108. As depicted, a resulting virtual native data set 1308 is generated.

As depicted in FIG. 13, the data set 1304 includes correlating data 1310 which can be used, for example, in locating the virtual native data set 1302 or in integrating the data set 1304 with the virtual native data set 1302.

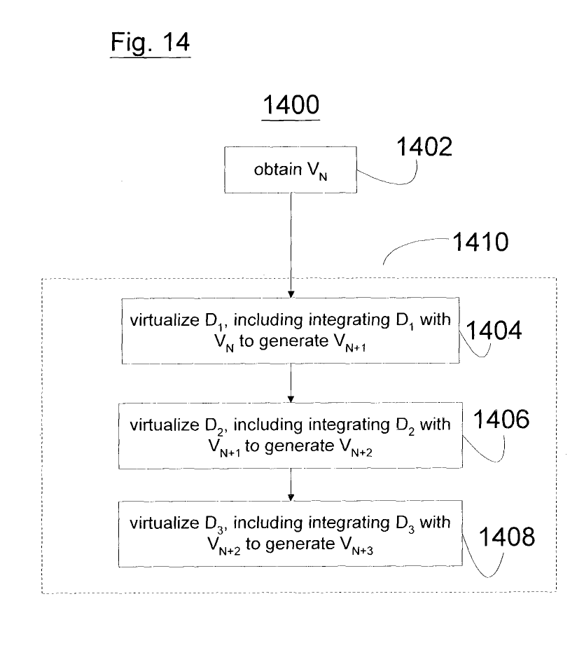

FIG. 14 is a flow diagram depicting one embodiment of a method 1400 including a series of iterations 1410, or data virtualization invocations, representing recursive iteration of data virtualization, each iteration including integrating a data set with a virtual native data set. At step 1402, a virtual native data set, V_{N}, is obtained, for example, by the data virtualization program 108 as depicted in FIG. 1. At step 1404, a first data set, D₁, is virtualized, for example, utilizing the data virtualization program 108, including integrating the first data set, D₁, with the obtained virtual native data set, V_{N}, to generate a first resulting virtual native data set, V_{N+1}. At step 1406, a second data set, D₂, is virtualized, for example, utilizing the data virtualization program 108, including integrating the second data set, D₂, with the first resulting virtual native data set, V_{N+1}, to generate a second resulting virtual native data set, V_{N+2}. At step 1408, a third data set, D₃, is virtualized, for example, utilizing the data virtualization program 108, including integrating the third data set, D₃, with the second resulting virtual native data set, V_{N+2}, to generate a third resulting virtual native data set, V_{N+3}.

Steps 1404, 1406, and 1408 represent individual iterations that together, as depicted by broken rectangle 1410, represent recursive iteration of data virtualiation. It is to be understood that any number of additional iterations are possible.

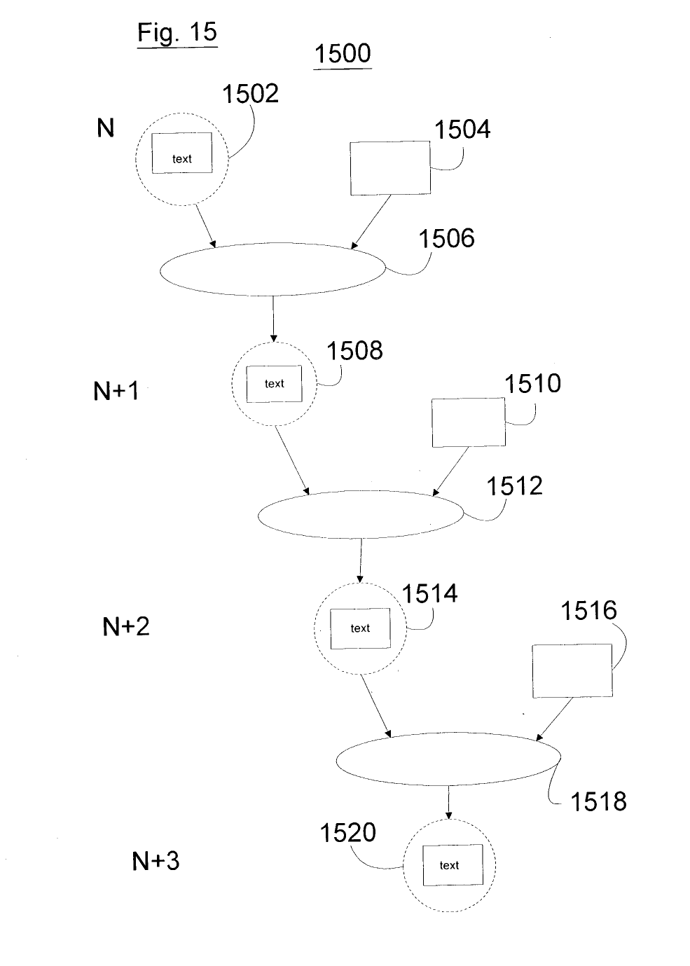

FIG. 15 is a block diagram depicting one embodiment of a method 1500 including recursive iteration of data virtualization, each iteration including integrating a data set, which can include external data from one or more external sources, with a virtual native data set. At each iteration, a data set of data sets 1504, 1510, 1516 is virtualized, including integration with a virtual native data set of virtual native data sets 1502, 1508, 1514. Each of the virtual native data sets 1502, 1508, 1514, 1520 can be viewed as a level of abstraction, the levels of abstraction represented by N, N+1, N+2, and N+3, and each level of abstraction after N resulting from layering, or integration, of virtualized data sets.

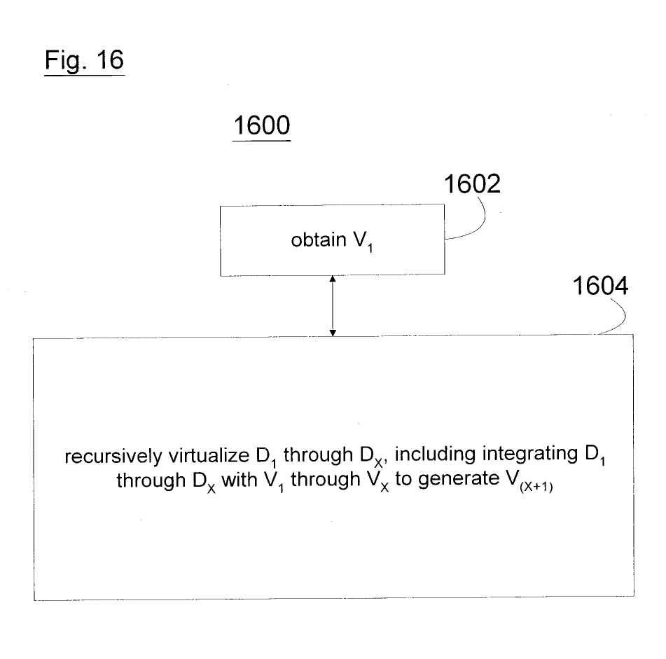

FIG. 16 is a flow diagram depicting one embodiment of a method 1600 including recursive iteration of data virtualization, each iteration including integrating a data set with a virtual native data set. At step 1602, a virtual native data set, V₁, is obtained, for example, by the data virtualization program 108 as depicted in FIG. 1. Step 1604 represents recursive iteration through a series of X abstraction levels (viewing the initial, obtained virtual native data set as the first level of abstraction) of virtualization of data sets D₁ through D_{X}, each iteration including integrating a data set of the data sets D₁ through D_{X} with a virtual native data set of virtual native data sets V₁ through V_{X} to ultimately generate resulting virtual native data set V_{(X+1)}.

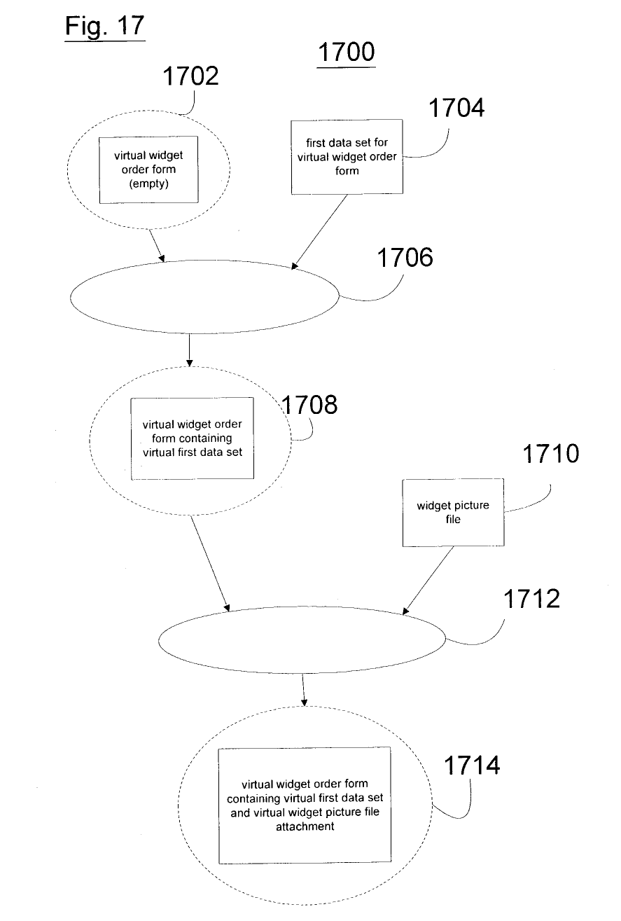

FIG. 17 is a block diagram depicting one embodiment of a method 1700 including a series of iterations representing recursive iteration of data virtualization, each iteration including integrating a data set with a virtual native data set. The embodiment depicted in FIG. 17 represents one particular example of how methods and systems according to some embodiments of the invention can be applied. As depicted, virtual native data set 1702 includes a virtual native data container, specifically, a virtual widget order form. As depicted, the virtual widget order form is empty of data contents, so that the data of the virtual widget order form specifies the structure of the form itself. Data set 1704 includes a first data set for the virtual widget order form. For example, data set 1704 could include the name of a customer who is to purchase widgets using the virtual widget order form, the type of widgets to be ordered, the quantity of widgets to be ordered, and the like.

Oval 1706 represents virtualization of the data set 1704, including integration of the data set 1704 with the obtained virtual native data set 1702, for example, utilizing the data virtualization program 108. As depicted, a resulting virtual native data set 1708 is generated, specifically, a virtual widget order form that has been modified to include data from the data set 1704. The widget order form could be modified to include, for example, data specifying the name of a customer who is to purchase widgets using the order form, the type of widgets to be ordered, the quantity of widgets to be ordered, and the like, the data having been obtained utilizing the data set 1704 and integrated into the widget order form.

Data set 1710 includes a widget picture data file. Oval 1712 represents virtualization of the data set 1710, including integration of the data set 1710 with obtained virtual native data set 1708, for example, utilizing the data virtualization program 108. Specifically, the widget picture data file is virtualized as an attachment added to the virtual widget order form. Resulting virtual native data set 1714 includes a virtual widget order form, complete with virtual native specific order information as well as a virtual native widget picture file attachment. Of course, any of the virtual native data sets 1702, 1708, 1714 can include virtualized native data obtained from external data, and any of the data sets 1704, 1710 can include external data.

The method 1700 presents just one simple example of many possible uses of data virtualization and recursive iteration of data virtualtization according to some embodiments of the invention. One skilled in the art could use the methods and systems of the invention for numerous different applications of various complexities, including, for example, any number of relational database system operations including access or manipulation of external data.

Better results can sometimes be obtained when actions taken which affect data of a virtual document or other virtual data set, such as data changes, additions, or deletions, are appropriately reflected by accordingly updating individual data sets, which can include external data sets and external databases. Since a particular virtualized data set may integrate data from numerous data sets or sources, the need can arise to appropriately propagate, or refrain from propagating, a data change received through or with respect to a virtual data set to various different data sets or sources.

In accordance with the above, in some embodiments, better results can sometimes be obtained with regard to propagation of data changes by accurately specifying relationships between data or by electing or specifying propagation rules. Data relationships or data propagation rules may be specified, for example, by a system administrator, prior to data access or manipulation by end users of the system. Additionally, in some embodiments of the invention, for data relationships or data propagation rules which are not specified or are otherwise unclear, a system administrator can be prompted by the system to specify the relationship or to clarify or select an appropriate propagation rule or option.

Appendix A, which forms a part of the specification of this application, provides some details of aspects of a commercially available system incorporating one embodiment of the invention, specifically, Lotus Enterprise Integrator™ software available from IBM Corporation, including measures to help assure data integrity and appropriate data propagation.

While the invention has been described and illustrated in connection with preferred embodiments, many variations and modifications as will be evident to those skilled in this art may be made without departing from the spirit and scope of the invention, and the invention is thus not to be limited to the precise details of methodology or construction set forth above as such variations and modification are intended to be included within the scope of the invention.

### Appendix A

Using Virtual Fields with Virtual Documents

Introduction

A Virtual Document is essentially equivalent to a native Notes document in every way, except that it is not stored in an NSF and all its data is external to the NSF, as a result you can add Virtual Fields to the Virtual Document. You do this by simply creating a Virtual Fields activity that monitors the same form that a Virtual Documents activity monitors. This effectively adds virtual fields to a document that is itself already virtual.

The concept may seem odd at first, but the ability to layer virtual fields over a virtual document adds significant extensibility and functionality not available to Virtual Documents alone. It also adds a level of complexity, with potential pitfalls, that needs to be considered before using this functionality in this manner. The user must be aware of his or her needs and whether this approach is suitable to solve a particular problem, or whether it can be solved more simply by using only Virtual Fields or only Virtual Documents. This section is intended to help you answer this question and it describes how to properly implement this advanced solution.

Advantages to Using Virtual Fields with Virtual Documents

There are two potential advantages to adding Virtual Fields to a Virtual Document:

The ability to include data from other external data sources, potentially from entirely different external data source systems, into a Virtual Document; and,

the ability to utilize some of the functionality from Virtual Fields activities, which is inherently not available in Virtual Documents activities, within in a Virtual Document.

It very important to understand that a Virtual Document stands on its own, and that, by definition, all its fields are virtual. These are the fields which are mapped in the Virtual Documents activity. A Virtual Documents activity monitors a single Notes Form, and all the mapped fields in that form are said to be virtualized and exist in a single table. Consequently, each table row corresponds to single Virtual Document. In addition, all the other various elements which comprise a Notes document are also virtualized in a external data source table, and hence the entire document is said to be virtual.

In essence, a Virtual Documents activity instantiates a complete Notes document, all of whose components and data exist external to the Domino NSF. This is the fundamental difference between Virtual Documents activities and Virtual Fields activities. While Virtual Documents virtualizes the entire document, Virtual Fields virtualizes individual fields and utilizes key documents stored in the NSF to hold the document level information and the all important key fields used to map a document to a particular external data source table row.

Virtual Documents removes the need to have and maintain stub documents, but at the expense of not being able to map various fields within a single document to different external data sources, nor can you have some fields stored natively (not virtual). Said another way, the document level nature of Virtual Documents means that all the fields in a Virtual Document always map to a single external data table row which describes the document as a whole; by contrast, multiple Virtual Fields activities can supply external data from multiple external sources to various virtual fields within a single document. The result of using a Virtual Fields activity to monitor the same form as a Virtual Documents activity is to add virtual fields to the virtual fields that are inherently part of the virtual document itself. If Virtual Field activity maps its fields from some other supported external system, you've essentially added the ability to create a Virtual Document that accesses data from multiple external systems, which is something you may not be able to do with Virtual Documents alone.

What Happens to the Virtual Field Key Documents

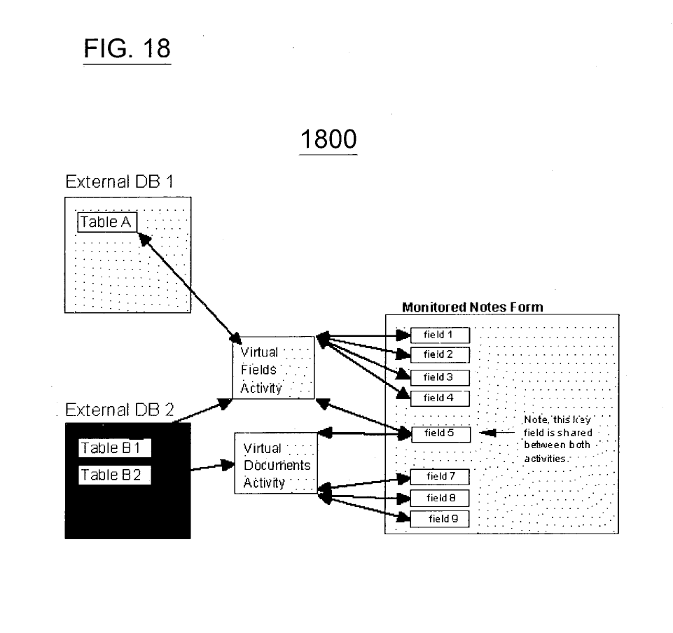

FIG. 18 is a block diagram 1800 depicting monitoring of a document, according to one embodiment of the invention. You may wonder how you can use Virtual Fields if you haven't created any key documents to supply keys. The short answer is that you do have key documents. The key documents are now actually the Virtual Documents themselves. This will be discussed in more detail later, but the primary requirement is that one or more fields in the Virtual Document (mapped by the Virtual Documents activity) can be used as key(s) for the Virtual Fields activity. It is not necessarily advantageous to think of Virtual Documents as strictly a substitute for Virtual Fields key documents, or as a way to use Virtual Fields without the need for maintaining and synchronizing native stub documents. The fact that the key documents are now virtual does not alleviate these issues, and in some ways adds more overhead. Think of Virtual Fields as a way to extend the external data access capabilities of Virtual Documents lo include data from multiple external sources and to add some extra functionality. Thought of correctly, Virtual Fields adds power to Virtual Documents, rather than Virtual Documents makes Virtual Fields easier to use.

Additional Functionality

Some Virtual Field functionality can be incorporated into Virtual Documents by configuring one or more Virtual Fields activities to monitor the same form as a Virtual Documents activity. Most notable of these is the ability to use multivalue data fields within a Virtual Document; fields mapped by the Virtual Documents activity cannot be multivalue fields. Any multivalue fields in a form monitored by a Virtual Documents activity would instead be mapped by a Virtual Fields activity with the appropriate multivalue parameters set. When viewing a Virtual Document, the fields mapped with the Virtual Documents activity will appear together with the multivalue fields, and any other fields, mapped by the Virtual Fields activity. Virtual Fields also has the notion of monitor order, whereby multiple Virtual Fields activities monitoring the same form can be set up to “run” in a specific order. In a typical case, the first Virtual Field activity using a key(s) supplied from the “key document”, populates a set of virtual fields in the document. The populated virtual fields from the first activity then supplies the key(s) for the next Virtual Field activity in the monitor order and so on. In some circumstances this ability to sequence activities can be very useful, but it is not possible with Virtual Documents alone since a single Virtual Documents activity exists in a given form. By adding two or more Virtual Fields activities to Virtual Documents, the fields mapped by the first Virtual Fields monitor can supply the key(s) for the second activity and so on as before. The only difference is that the Virtual Document supplies the key(s) for the first Virtual Fields monitor. In the context of monitor order processing, you can think of the Virtual Documents activity as always having a monitor order of 0; that is, it always runs first.

Adding Virtual Fields to Virtual Documents

Adding virtual fields to a virtual document is somewhat of a misnomer since the fields mapped by the Virtual Document activity are of course already virtual. What we are really doing here is adding more virtual fields mapped in one or more Virtual Fields activities. This is simply accomplished by creating a Virtual Fields activity that monitors the same Notes form which is being monitored by a Virtual Documents activity. It's assumed that you are already familiar with the creation of Virtual Documents and Virtual Fields activities.

The most important aspect of creating the Virtual Fields activity involves the selection of the key field(s). Just as ‘regular’ Virtual Fields activities require that the key fields exist in the key documents, the key field(s) here must be also be mapped by the Virtual Documents activity. Because the key(s) are mapped by both activities they must be common to both external system tables. Since Virtual Documents activities do not have a notion of key(s), they will appear as any other data field in the Virtual Document mapping section, but they will then be mapped as keys in the Virtual Fields activity.

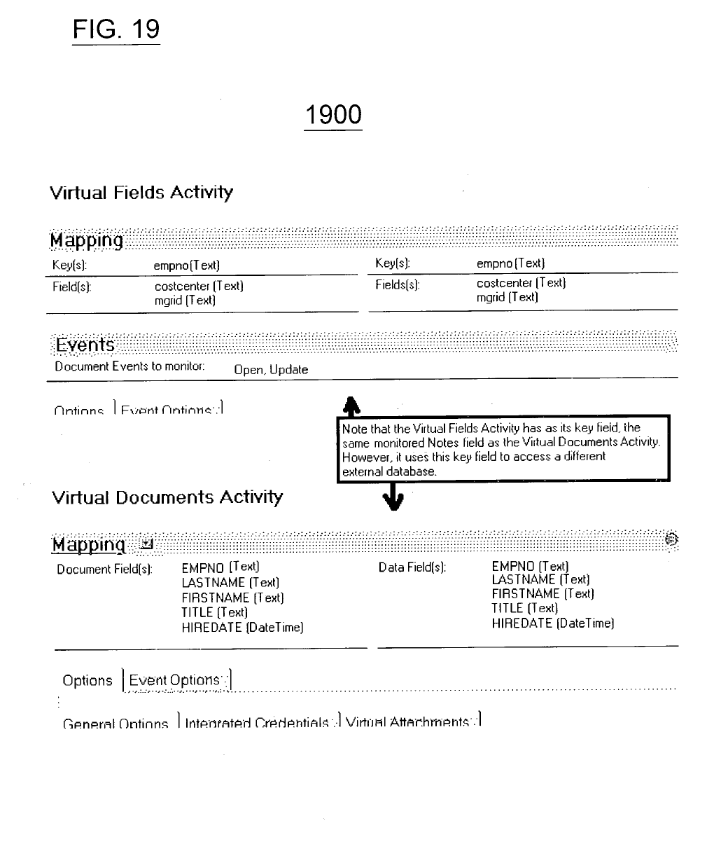

FIG. 19 is a block diagram 1900 depicting a relationship between virtual fields activity and virtual documents activity, according to one embodiment of the invention. As depicted in FIG. 19, empno is mapped as a data field in the Virtual Documents activity along with some other employee information. All these fields map to the external system employee information table. The Virtual Fields activity maps the same empno field to another external system table, along with some other data relating to the employee's department. The empno field is the only field that need be in common between the two tables and the corresponding activity mapping. When these activities are running, the Virtual Documents activity will first construct the Virtual Document which will essentially provide the needed key(s) for the Virtual Fields activity to be able to access its external system table. The end result is a Notes Document which is a composite virtual document; that is, it contains virtual fields supplied by both the Virtual Documents activity and the Virtual Fields activity using data from two different external system tables.

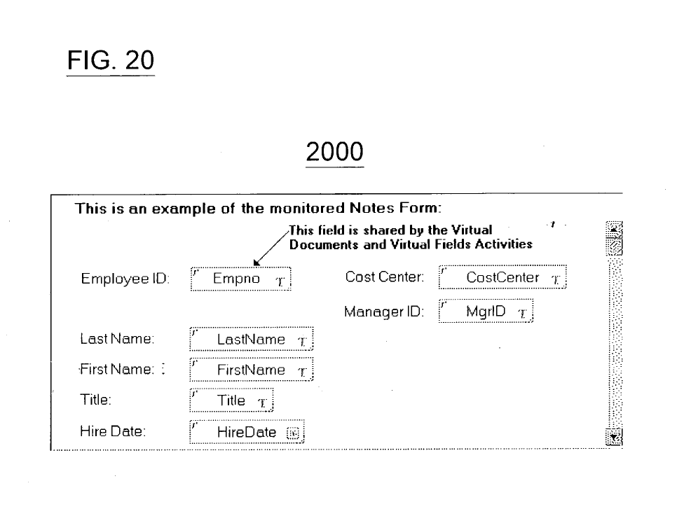

This example can be extended further to include one or more additional Virtual Fields activities, as depicted in FIG. 20, which is a block diagram 2000 depicting a monitored document, according to one embodiment of the invention. These activities could use the same empno field as the key, or use other fields as keys, possibly supplied by other Virtual Fields activities and using the Virtual Fields monitor order capability. Refer to the Virtual Fields activity chapter for more information about monitor order.

With some caveats, almost anything that can be done with regular Virtual Fields activities using key documents can be done with Virtual Fields and Virtual Documents together. The next sections will cover some of the special issues which arise when using these two types of activity together.

Managing the Key Field Under Different Scenarios

As implied earlier, all the Virtual Fields activity key(s) which exist in the Virtual Documents table must also exist in the Virtual Fields table, or else accessing the virtual document will fail because the lookup on the Virtual Fields table will fail. In other words, attempting to open a virtual document that contains a key value that does not exist in the Virtual Fields table results in an Notes open failure. Under normal circumstances this should not happen, but certain improper configurations and/or error conditions could lead to this situation.

Scenario 1: One-to-Many Record Correspondence

This situation arises when there is not a strict one-to-one correspondence between the records in the Virtual Documents table and the Virtual Fields table. This could be described as a one-to-many record correspondence.

For example, suppose an external system table contains employee data for 100 employees. This table can easily be virtualized into a Domino environment through a Virtual Documents activity in the usual manner. One of the columns in this table provides a department code indicating the department to which employee is currently assigned. Now suppose a second external table contains department data for each of the company's 12 departments, using the department code as a unique key. Each department has one or more employees assigned to it; this is the one-to-many relationship. The goal is to consolidate employee information with information about the employee's current department on a single Notes form. This would make the consolidated document appear as a single Notes document which can be manipulated in exactly the same ways a normal Notes document can be manipulated in a Domino environment. As described earlier, the only way to supply these additional virtual fields (department data) to your virtual document (employee data) is by using a Virtual Fields activity which monitors the same Notes form as the Virtual Documents activity, and mapping the department code field as the key in the Virtual Fields activity.

However, if the Virtual Fields activity is monitoring ALL Notes events, including creates, updates and deletes, a problem will arise when an employee is terminated, or transferred to another department, or a new employee is hired. Consider the following cases:

If an employee Fred Waters in department 4 is terminated, and the Notes application is intended to only contain information about active employees, simply deleting Fred's document has the following consequences:

1. Fred's record in the Virtual Documents table will be marked as deleted; this allows Domino to replicate the document deletion to other potential database replicas.

2. Since the Virtual Fields activity is monitoring delete events, it will delete Fred's former department record from the Virtual Fields department data table, using 4 as the key.

3. Fred's former coworker's records in department 4 will no longer be accessible through Notes, since opening the virtual document will result in a Virtual Fields lookup failure for their department data.

If Fred is transferred from department 4 to department 7, updating Fred's document has the following consequences, but only if key field updates are allowed in the Virtual Fields activity (they are BLOCKED by default):

4. Fred's department code in the Virtual Documents employee information table will be updated from 4 to 7

5. Since the Virtual Fields activity is monitoring update events, the department code record in the Virtual Fields department information table will also be updated from 4 to 7, assuming the Virtual Fields activity is set to allow key field updates.

6. Updating the key field with a new value will probably have many negative consequences, ranging from document access problems for other employees still in department 4 to duplicate key errors from the external system table.

If Bob Smith is hired as a new employee to help Fred out in department 4, the following will occur:

7. Bob Smith's record will be inserted into the Virtual Documents table, with 4 as his department code.

8. Since the Virtual Fields activity is monitoring create events, a new row for department 4 will be created in the Virtual Fields department information table.

9. This may lead to duplicate key problems since there is already a department 4, and it really doesn't make sense since we do not want to reenter department information for department 4, but instead want to add a new employee who will work in department 4.

Solution

What we really want to do in this scenario is to make the Virtual Fields activity a Read Only activity that simply uses the department information table as a lookup table to provide department information when each employee's documents is opened. This is very easily accomplished by always setting the Virtual Fields activity to only monitor OPEN events when you have this one-to-many scenario. Set up this way, deletions and updates to an employees document will only affect the employee record in the Virtual Documents employee table. Creating a new employee record will simply involve entering the employee information including the department code. When the new employee's record is subsequently opened, the correct department information will be displayed along side the employee information.

A special case arises if you do want to be able to update department information from within an employee's virtual document. In this situation, allow the Virtual Fields activity to monitor update events, but be sure that the update event option for Key Field Updates is set to Block (which is the default). This will allow you to edit department information, but still allow you to transfer an employee to a different department without running into the problem described above, where the department code key is changed in the department information table as part of the update. If you are already familiar with the ‘regular’ use of Virtual Fields activities, you may recognize this one-to-many scenario. This typically occurs when using multiple Virtual Fields activities with a prescribed monitor order. In this scenario, the first Virtual Fields activity in the monitor order provides the key for second Virtual Fields activity which accesses a read only type lookup table such as the department information table described above. The same problems and solutions described above apply in this case. The only difference in the virtual documents context is that the Virtual Documents activity essentially plays the role of the first activity by providing the key for the Virtual Fields activity.

Scenario 2: One-to-One Record Correspondence

There may be circumstances where it is desirable to have read/write access to the Virtual Fields table. This would include the case where there is a one-to-one relationship between the records in the two tables. For example, instead of department information in the Virtual Fields table, suppose the table simply included more employee specific information concerning job performance. The key might be the employee's social security number. In this case, when an employee is terminated and the document deleted from the Notes application, it may be preferable to delete all the employees records from both tables. Also, being able to update information about the employee, including job performance data in the Virtual Fields table, may be desirable. Similarly, a new employee would always result in new records being created in both tables.

In this situation you do have a one-to-one relationship between the two tables, as a result, you may not want to block key field updates, because unlike the example where the key was a department code shared by multiple employees, here the key uniquely identifies a single employee. In our example, if an incorrect social security number is changed but the key field update is blocked in the Virtual Fields activity, a subsequent attempt to open the employees record will fail because the lookup into the Virtual Fields table will now fail since the key was not affected by the update.

Key Initialization

The concept and process of initializing keys with Virtual Fields activities usually involves the creation of “key documents” which are native Notes documents stored in the Notes database. They typically only contain key field data used by the Virtual Fields activity to access the corresponding external system table row, so there is one key document created for each row in the table. When using Virtual Fields with Virtual Documents activities to produce a composite document as described in the above preceding sections, the notion of key initialization is somewhat inconsistent with the intended functionality. It is usually assumed that the external table to be used with the Virtual Documents activity has already been “virtualized”. See the Virtual Documents chapter for details on external system table virtualization. In this case, the documents which will play the roll of key documents for the Virtual Fields activity already exist. The addition of virtual fields through the Virtual Fields activity simply requires a common key field and table column as described in earlier examples. As you can see, in this scenario there are simply no keys to initialize since the virtual documents already exist.

Because of the transparency of Virtual Documents, it is possible to use the traditional Virtual Fields key initialization in conjunction with Virtual Documents. Assuming that both activities have been set up to monitor the same Notes form and have a common field to act as a key for the Virtual Fields activity, starting the Key Initialization process in the Virtual Fields activity will essentially create virtual key documents. As with ‘normal’ key initialization, one virtual key document will be created for each row in the Virtual Fields table. Of course, each new virtual key document will in turn correspond to a newly created row in the Virtual Documents table. That table must have as a minimum one column for each key used by the Virtual Fields activity.

Note The Virtual Documents activity must be running during the key initialization, or else traditional non-virtual documents will be created.

This above technique illustrates the flexibility of using Virtual Documents. With this method, you can use an existing table used by a Virtual Fields activity to essentially populate another table mapped to a Virtual Documents activity and thus creating virtual key documents. However, as discussed earlier in this chapter, using virtual documents solely as a way to remove so native key documents is not necessarily a good idea, unless it is vital to keep the size of an NSF at a minimum and to keep all data external to the Notes database. However, if this is the intent, a better solution would be to remove the Virtual Fields activity from the picture all together, and just virtualize the existing Virtual Fields table using only Virtual Documents activity to monitor the Notes form.

Automatic Background Virtualization and Key Synchronization Problems

Virtualization is the process used by a Virtual Documents activity to adapt an external system table in such a way as to make each row represent a Notes Document. This occurs automatically and immediately when creating a new virtual document through a Notes client. The corresponding row is inserted into the external table when the document is saved. Virtualization can also be done automatically by a background process which scans the external table for existing rows that have not been virtualized as Notes documents, and thereby makes them accessible through Domino. This feature is useful when the external data table already contains data and you want to make the data automatically accessible through Domino. The external data source table is also periodically scanned for rows that may be added through a non-Notes client or process and needs to be virtualized into the NSF. See the Virtual Documents activities chapter for more details.

If a Virtual Fields activity is also monitoring the same form, virtualization does not have a direct impact on the Virtual Fields activity or the external table associated with it. However, as described earlier, virtual document must be a common data field in the Virtual Documents activity that also serves as the key for the Virtual Fields activity. If an external table is virtualized and it contains rows with key values that do not exist in the Virtual Fields table, an error will occur when trying to subsequently access the virtual document because the lookup on the Virtual Fields table has failed. If the problem is simply with incorrect key data, leave the Virtual Documents activity running but shut down the Virtual Fields activity. You will then be able to either delete the offending virtual documents or open and update the virtual documents with the correct key data, then restart the Virtual Field activity. Conversely, if the problem is with incorrect key data in the Virtual Fields table, you will have to manually update (for example, through a SQL client) the external data source table with the correct key data, or add the necessary rows, to match the data in the Virtual Documents table.

If you have a situation where some of the records in the Virtual Documents table simply do not have applicable data in the Virtual Fields table you may need to make special provisions. For example, the Virtual Documents table contains all company employee data, and the employee's department code is used as a key to lookup department information in the Virtual Fields table. However, some employees are independent contributors and don't have a department number (it's NULL in the Virtual Documents table). This will clearly cause a problem when accessing this document since the lookup on Virtual Fields table will fail.

Again, it is important to choose a data value(s) in the Virtual Documents table that can always serve as a unique key(s) for the Virtual Fields table. An easy fix for this example might be to simply add a row to the department information table (Virtual Fields table) which has a special department number key (0 for example), with all other department information set to null. Then assign the special department number to each of the applicable employee records in the employee information table (Virtual Documents table). Another more sophisticated approach could be to simply use a post open formula for the Virtual Documents activity which always sets the department number field to 0 if it is null when opening the virtual document.

As mentioned above, when creating a virtual document through a Notes client, the corresponding external row will be automatically inserted and virtualized into the external table by the Virtual Documents activity when the document is saved. A new row will also be inserted into the Virtual Fields table for the fields mapped by the Virtual Fields activity if it is monitoring create events. Since the two operations occur together, there should be no synchronization issues. If the Virtual Fields activity is not monitoring create events, it is assumed that the entered key already exist in the Virtual Fields table.

Error Conditions and Key Field Synchronization Problems

Assuming the external table used by the Virtual Documents activity and the table(s) used by the Virtual Fields activity(s) are initially synchronized; every row in the Virtual Documents table contains a valid unique key(s) for the Virtual Fields table, problems can arise when certain error conditions are encountered. However, problems will occur only when the Virtual Fields activity is monitoring any of the events, which include Create, Update, and Delete events. Depending on your particular write application, you may or may not be using the Virtual Field activity(s) in a read/write fashion. If you are using the Virtual Fields activity in a read-only fashion by only monitoring the Open event, the error conditions discussed in this section are not applicable. See the section “Managing the Key Field Under Different Scenarios” for more information.

When creating or updating a document, if an error occurs inserting or updating a record into the Virtual Fields or Virtual Documents table, the document is not created and an error message is returned.

For example, if connectivity is lost between Domino and the external system for the Virtual Fields table, a connectivity error will be provided in a dialog box and the error will be logged in the Virtual Fields activity log. The Virtual Document activity processing will not occur and no records will be inserted/updated in the Virtual Document table. All Virtual Fields activity processing is performed before Virtual Document activity processing when inserting, updating, or deleting virtual documents. Again, this can only occur if the Virtual Fields activity is monitoring one or more of these events.

A problem may occur if an error occurs in the Virtual Document processing, which always occurs after all Virtual Fields activity(s) processing is finished. The result of this is that the Virtual Field table may be updated, or a new row inserted, or a row deleted, depending on the event. However, the corresponding operation fails on the Virtual Documents table, perhaps due to a similar connectivity issue as in the earlier example. At this time there is no rollback on the Virtual Fields table operation. The following describes how to handle this situation, and assumes a single Virtual Fields table with a single key.

If creating a new document the Virtual Fields table will contain a new row. When the error condition is resolved, an attempt to create the document may still fail because the Virtual Fields activity will try to reinsert the row with the same key that already exists, resulting in a duplicate key error. To resolve this problem, first delete the new row in the Virtual Fields table or shut down the Virtual Fields activity, prior to attempting to create the document again. After, restart the Virtual Fields activity if you shut it down.

If updating a document the problems are similar to creating a new document. The Virtual Fields activity will first update its table with any modified data. A synchronization problem arises only when key field updates are allowed by the Virtual Fields activity (they are blocked by default), and an error occurs in updating the Virtual Documents row with the new key value. A subsequent attempt to open the Virtual Document will fail because it will try to access the Virtual Fields table with what is now a nonexistent key, because it has already been changed in the Virtual Fields table but not in the Virtual Documents table. To rectify this situation, shut down only the Virtual Fields activity, open the document and update the key value field with the correct key, then save and close the document Restart the Virtual Fields activity and reopen the document you should now see all the correct data.

If deleting a document the Virtual Fields activity will delete the corresponding row in the Virtual Fields table. When the error condition is resolved, you will be able to successfully delete the document and no error will be reported as a result of the Virtual Fields table row already being deleted. However, an attempt to open the document after the initial error has occurred will result in an error, since the Virtual Fields record has already been deleted so the lookup on that record will fail.

Non-Key Data Fields

Now that the perils of the Virtual Field key field(s) and how to set up the activities with special regards to the key(s) has been explained, how should other non-key data fields be handled? As discussed the only fields that must be mapped in both activities are the fields which will act as the key(s) for the Virtual Field Activity(s). Of course this means these fields must have corresponding columns in both the Virtual Fields and Virtual Documents tables. Beyond this, no other fields need to be mapped in both activities. Whether or not other data fields need to mapped depends solely on your particular application and how the external system tables are set up and used.

Using an earlier example where the employee information was stored in a virtualized Virtual Documents table, and look-ups were used into a Virtual Fields table to access the employee's department information, this would illustrate a case where there would typically be no'shared data between the two tables, except for the department code key. The department code key field would be mapped by both activities.

Considering the example where the Virtual Fields table contains job performance data for a particular employee, using a unique employee id (for example, social security number) as the key, you might have a different situation since you now have the previously discussed one-to-one relationship between records in the two tables. As such, there might be duplicated information between the two tables. For example, the employee's full name and telephone number might be included in both tables. If this information, say the phone number, needs to be updated but it is only mapped by one activity, only that activity's table will be updated, and unexpected results may occur. For example, if the phone number is updated but the phone number field is only mapped by the Virtual Documents activity only the Virtual Documents table will be updated. The Virtual Fields table will not be updated with the new number. From the perspective of the Notes application this does not pose a problem since the unmapped phone number column in the Virtual Fields table will never be accessed. However, you may have some other external application which depends on all the information in the table being used by the Virtual Fields activity to be correct and up to date. As a general rule of thumb, any common data column which is mapped in one activity should also be mapped by the other activity unless the field is a read only field.

Be aware that any PRE or POST-event formulas which are run in one activity will not automatically apply to another activity. For example, if a pre-update formula is run to always validate and pre-pend an area code to the phone number field in the Virtual Fields activity, it will have to be duplicated in the Virtual Documents activity to achieve the same results.

What is claimed is:

1. A method for virtualizing data as virtual native data to a host operating environment, the method comprising:
obtaining a first set of virtual native data, the first set of virtual native data being virtualized as virtual native data to the host operating environment, and at least a portion of the first set of virtual native data comprising data from a source that is external to the host operating environment; and
virtualizing a second set of data as virtual native data to the host operating environment, at least a portion of the second set of data comprising data from a source that is external to the host operating environment, comprising integrating at least a portion of the second set of data with at least a portion of the obtained first set of virtual data.

2. The method of claim 1, wherein virtualizing data comprises enabling data to be useable through the host operating environment as a first class participant in the host operating environment.

3. The method of claim 1, wherein virtualizing the second set of data does not require nonvolatile storage of data of the second set as native data to the host operating environment.

4. The method of claim 1, comprising allowing a user to utilize virtualized data such that the virtualization of the data is transparent to the user.

5. The method of claim 1, wherein integrating at least a portion of the second set of data with at least a portion of the obtained first set of virtual data comprises generating a first resulting set of virtual native data.

6. The method of claim 5, comprising virtualizing a third set of data as virtual native data to the host operating environment, at least a portion of the third set of data comprising data from a source that is external to the host operating environment, comprising integrating at least a portion of the third set of virtual native data with at least a portion of the first resulting set of virtual native data.

7. The method of claim 5, wherein generating a first resulting set of virtual native data comprises at least one of generating, modifying, and manipulating a virtual native data object utilizing data of the first and the second sets.

8. The method of claim 1, comprising repeating the virtualizing step, including integrating data sets, wherein at least one of the data sets integrated at each virtualizing step is obtained as a result of a previous virtualizing step.

9. The method of claim 1, wherein the first set of virtual native data comprises correlating data, and comprising using the correlating data to facilitate location of the second set of data.

10. The method of claim 1, wherein the second set of data comprises correlating data, and comprising using the second set of data to facilitate location of the first set of virtual native data.

11. The method of claim 1, wherein integrating at least a portion of the second set of data with at least a portion of the obtained first set of virtual data comprises combining at least a portion of the second set of data with at least a portion of the obtained first set of virtual data.

12. The method of claim 1, wherein integrating at least a portion of the second set of data with at least a portion of the obtained first set of virtual data comprises associating at least a portion of the second set of data with at least a portion of the obtained first set of virtual data.

13. The method of claim 12, wherein integrating at least a portion of the third set of virtual native data with at least a portion of the first resulting set of virtual native data comprises generating a second resulting set of virtual native data.

14. The method of claim 13, comprising virtualizing a fourth set of data as virtual native data to the host operating environment, at least a portion of the fourth set of data comprising data from a source that is external to the host operating environment, comprising integrating at least a portion of the fourth set of virtual native data with at least a portion of the second resulting set of virtual native data.

15. A system for virtualizing data as virtual native data to a host operating environment, the system comprising:
a client computer through which data can be retrieved through the host operating environment; and
at least one server computer connectable to the client computer and capable of being utilized in making the host operating environment available to the client computer, wherein the at least one server computer is capable of being utilized for:
obtaining a first set of virtual native data, the first set of virtual native data being virtualized as virtual native data to the host operating environment, and at least a portion of the first set of virtual native data comprising data from a source that is external to the host operating environment; and
virtualizing a second set of data as virtual native data to the host operating environment, at least a portion of the second set of data comprising data from a source that is external to the host operating environment, comprising integrating at least a portion of the second set of data with at least a portion of the obtained first set of virtual data.

16. The system of claim 15, wherein the first set of virtual native data comprises correlating data useable to facilitate location of the second set of data.

17. The system of claim 15, wherein the second set of data comprises correlating data useable to facilitate location of the first set of virtual native data.

18. The system of claim 15, wherein the client computer is connectable to the at least one server computer through a network.

19. The system of claim 15, comprising an external database connectable to the network, the external database being external to the host operating environment, from which external data is obtained.

20. The system of claim 15, wherein the first set of data comprises a data container.

21. The system of claim 20, wherein the data container comprises a document.

22. A computer usable medium storing program code which, when executed on a computerized device, causes the computerized device to execute a method for virtualizing data as virtual native data to a host operating environment, the method comprising:
obtaining a first set of virtual native data, the first set of virtual native data being virtualized as virtual native data to the host operating environment, and at least a portion of the first set of virtual native data comprising data from a source that is external to the host operating environment; and
virtualizing a second set of data as virtual native data to the host operating environment, at least a portion of the second set of data comprising data from a source that is external to the host operating environment, comprising integrating at least a portion of the second set of data with at least a portion of the obtained first set of virtual data.
